(19) United States
(12) Patent Application Publication
(10) Pub. No.: US 2023/0115943 A1
(43) Pub. Date: Apr. 13, 2023

(54) METHODS OF TREATING ADIABATIC COOLING MEDIA IN EVAPORATIVE COOLING SYSTEMS

(71) Applicant: CHEMTREAT, INC., Glen Allen, VA (US)

(72) Inventors: Santanu BANERJEE, Glen Allen, VA (US); Benjamin NIEMASECK, Chesterfield, VA (US); Tzong Y. DU, Glen Allen, VA (US); Valerie M. RICHTER, Fountain Hills, AZ (US)

(73) Assignee: CHEMTREAT, INC., Glen Allen, VA (US)

(21) Appl. No.: 17/961,180

(22) Filed: Oct. 6, 2022

Related U.S. Application Data
(60) Provisional application No. 63/252,792, filed on Oct. 6, 2021.

(51) Int. Cl. C09K 5/04

(52) U.S. Cl. CPC C09K 5/048

(57) ABSTRACT

A method for applying a chemical treatment to a cooling medium in an evaporative cooling system. The method includes applying the chemical treatment to the cooling medium, and the chemical treatment includes at least one of a phosphonate and a dispersant polymer.

This application claims priority to Provisional Application No. 63/252,792, filed Oct. 6, 2021. The entire contents of the prior application are hereby incorporated by reference herein in their entirety.

### TECHNICAL FIELD

This application relates to methods for treating adiabatic cooling media using chemical treatment.

### BACKGROUND

Evaporative cooling systems are common. In evaporative cooling, a device cools air through the evaporation of water. Evaporative cooling differs from other air conditioning systems, which use vapor-compression or absorption refrigeration cycles. Evaporative cooling relies on the principle that water will absorb a relatively large amount of heat in order to evaporate (i.e., it has a large enthalpy of vaporization). The temperature of dry air can be dropped significantly through the phase transition of liquid water to water vapor (evaporation). This can cool air using much less energy than refrigeration. Evaporative cooling of air can also increase humidity in drier climates.

Adiabatic cooling media may be employed in evaporative cooling systems. An adiabatic process is a type of thermodynamic process which occurs without transferring heat or mass between the system and its surroundings. Unlike an isothermal process, an adiabatic process transfers energy to the surroundings only as work. In an adiabatic process, total enthalpy is unchanged. Total enthalpy is the sum of sensible heat, which is the result of the energy from a change in temperature to a gas or object, and latent heat, which is the result of any change in phase of a solid, liquid or gas.

Adiabatic cooling media are commonly used in large data centers and other institutional cooling using evaporating cooling systems. These media are typically made of cellulose-based materials which are sensitive to chemical treatment programs that can destroy the media integrity. Indeed, many cooling media vendors advise not treating the cooling media in order to avoid reduction in cooling efficiency and overheating of data center equipment. Hence, customers do not conventionally use cooling water treatment programs for evaporative cooling systems. Instead, customers will typically change the media frequently to continue their operation. This practice leads to high operating cost. As a result, there is a substantial need for better methods for treating adiabatic cooling media that do not involve frequently changing of the cooling media.

### SUMMARY

The disclosed methods and systems solve these and other problems by applying chemical treatment to adiabatic cooling media in an evaporative cooling system. It was discovered by the inventors that, by adding the chemical treatment to adiabatic cooling media, the lifespan of the media could be increased significantly, e.g., from in a range of 2 to 3 years (without treatment) to in a range of 5-6 years (with treatment). The increased lifespan of the adiabatic cooling media increases the efficiency of the data center and reduces maintenance costs.

In particular, disclosed methods and systems will (i) extend life of cooling media by 3 to 5 years, (ii) save labor and material cost for the customer by 40% or more, (iii) maximize uptime and reduce pretreatment cost, (iv) reduce cooling media wastage and save water usage, (v) eliminate biofilm related degradation of media and address Legionella concerns, (vi) differentiate against competitors, and (vii) and generate incremental revenue.

In an embodiment, there is provided a method for applying a chemical treatment to a cooling medium in an evaporative cooling system. The method includes applying the chemical treatment to the cooling medium, and the chemical treatment comprises at least one of a phosphonate and a dispersant polymer.

### BRIEF DESCRIPTION OF THE DRAWINGS

FIG. 1 is a schematic diagram of an adiabatic cooling medium in an evaporative cooling system according to embodiments.

FIGS. 2A and 2B show top (FIG. 2A) and bottom (FIG. 2B) scanning electron micrographs of an untreated cooling media sample of Munter's CELdek®. FIG. 2C is a photograph of a portion of the media sample. FIG. 2D illustrates the result of an x-ray spectroscopy analysis on the media sample.

FIGS. 3A and 3B show top (FIG. 3A) and bottom (FIG. 3B) scanning electron micrographs of an untreated cooling media sample of Munter's GLASdek®. FIG. 3C is a photograph of a portion of the media sample. FIG. 3D illustrates the result of an x-ray spectroscopy analysis on the media sample.

FIGS. 4A and 4B show top (FIG. 4A) and bottom (FIG. 4B) scanning electron micrographs of a cooling media sample of Munter's CELdek® treated with water. FIG. 4C is a photograph of a portion of the media sample after an MOC test. FIG. 4D illustrates the result of an x-ray spectroscopy analysis on the media sample after the MOC test.

FIGS. 5A and 5B show top (FIG. 5A) and bottom (FIG. 5B) scanning electron micrographs of a cooling media sample of Munter's GLASdek® treated with water. FIG. 5C is a photograph of a portion of the media sample after an MOC test. FIG. 5D illustrates the result of an x-ray spectroscopy analysis on the media sample after the MOC test.

FIGS. 6A and 6B show top (FIG. 6A) and bottom (FIG. 6B) scanning electron micrographs of a cooling media sample of Munter's CELdek® treated with sulfuric acid. FIG. 6C is a photograph of a portion of the media sample after an MOC test. FIG. 6D illustrates the result of an x-ray spectroscopy analysis on the media sample after the MOC test.

FIGS. 7A and 7B show top (FIG. 7A) and bottom (FIG. 7B) scanning electron micrographs of cooling media sample of Munter's GLASdek® treated with sulfuric acid. FIG. 7C is a photograph of a portion of the media sample after an MOC test. FIG. 7D illustrates the result of an x-ray spectroscopy analysis on the media sample after the MOC test.

FIGS. 8A and 8B show top (FIG. 8A) and bottom (FIG. 8B) scanning electron micrographs of a cooling media sample of Munter's CELdek® treated with a cleaning sample according to an embodiment. FIG. 8C is a photograph of a portion of the media sample after an MOC test. FIG. 8D illustrates the result of an x-ray spectroscopy analysis on the media sample after the MOC test.

FIGS. 9A and 9B show top (FIG. 9A) and bottom (FIG. 9B) scanning electron micrographs of a cooling media sample of Munter's GLASdek® treated with a cleaning sample according to an embodiment. FIG. 9C is a photograph of a portion of the media sample after an MOC test. FIG. 9D illustrates the result of an x-ray spectroscopy analysis on the media sample after the MOC test.

FIGS. 10A and 10B show top (FIG. 10A) and bottom (FIG. 10B) scanning electron micrographs of a cooling media sample of Munter's CELdek® treated with a cleaning sample according to an embodiment. FIG. 10C is a photograph of a portion of the media sample after an MOC test. FIG. 10D illustrates the result of an x-ray spectroscopy analysis on the media sample after the MOC test.

FIGS. 11A and 11B show top (FIG. 11A) and bottom (FIG. 11B) scanning electron micrographs of a cooling media sample of Munter's GLASdek® treated with a cleaning sample according to an embodiment. FIG. 11C is a photograph of a portion of the media sample after an MOC test. FIG. 11D illustrates the result of an x-ray spectroscopy analysis on the media sample after the MOC test.

FIGS. 12A and 12B show top (FIG. 12A) and bottom (FIG. 12B) scanning electron micrographs of a cooling media sample of Munter's CELdek® treated with a cleaning sample according to an embodiment. FIG. 12C is a photograph of a portion of the media sample after an MOC test. FIG. 12D illustrates the result of an x-ray spectroscopy analysis on the media sample after the MOC test.

FIGS. 13A and 13B show top (FIG. 13A) and bottom (FIG. 13B) scanning electron micrographs of a cooling media sample of Munter's GLASdek® treated with a cleaning sample according to an embodiment. FIG. 13C is a photograph of a portion of the media sample after an MOC test. FIG. 13D illustrates the result of an x-ray spectroscopy analysis on the media sample after the MOC test.

FIGS. 14A and 14B show top (FIG. 14A) and bottom (FIG. 14B) scanning electron micrographs of a cooling media sample of Munter's CELdek® treated with a cleaning sample according to an embodiment. FIG. 14C is a photograph of a portion of the media sample after an MOC test. FIG. 14D illustrates the result of an x-ray spectroscopy analysis on the media sample after the MOC test.

FIGS. 15A and 15B show top (FIG. 15A) and bottom (FIG. 15B) scanning electron micrographs of cooling media sample of Munter's GLASdek® treated with a cleaning sample according to an embodiment. FIG. 15C is a photograph of a portion of the media sample after an MOC test. FIG. 15D illustrates the result of an x-ray spectroscopy analysis on the media sample after the MOC test.

FIGS. 16A and 16B show top (FIG. 16A) and bottom (FIG. 16B) scanning electron micrographs of a cooling media sample of Munter's CELdek® treated with a cleaning sample according to an embodiment. FIG. 16C is a photograph of a portion of the media sample after an MOC test. FIG. 16D illustrates the result of an x-ray spectroscopy analysis on the media sample after the MOC test.

FIGS. 17A and 17B show top (FIG. 17A) and bottom (FIG. 17B) scanning electron micrographs of a cooling media sample of Munter's GLASdek® treated with a cleaning sample according to an embodiment. FIG. 17C is a photograph of a portion of the media sample after an MOC test. FIG. 17D illustrates the result of an x-ray spectroscopy analysis on the media sample after the MOC test.

FIGS. 18A and 18B show top (FIG. 18A) and bottom (FIG. 18B) scanning electron micrographs of a cooling media sample of Munter's CELdek® treated with a cleaning sample according to an embodiment. FIG. 18C is a photograph of a portion of the media sample after an MOC test. FIG. 18D illustrates the result of an x-ray spectroscopy analysis on the media sample after the MOC test.

FIGS. 19A and 19B show top (FIG. 19A) and bottom (FIG. 19B) scanning electron micrographs of a cooling media sample of Munter's GLASdek® treated with a cleaning sample according to an embodiment. FIG. 19C is a photograph of a portion of the media sample after an MOC test. FIG. 19D illustrates the result of an x-ray spectroscopy analysis on the media sample after the MOC test.

FIGS. 20A and 20B show top (FIG. 20A) and bottom (FIG. 20B) scanning electron micrographs of a cooling media sample of Munter's CELdek® treated with a cleaning sample according to an embodiment. FIG. 20C is a photograph of a portion of the media sample after an MOC test. FIG. 20D illustrates the result of an x-ray spectroscopy analysis on the media sample after the MOC test.

FIGS. 21A and 21B show top (FIG. 21A) and bottom (FIG. 21B) scanning electron micrographs of a cooling media sample of Munter's GLASdek® treated with a cleaning sample according to an embodiment. FIG. 21C is a photograph of a portion of the media sample after an MOC test. FIG. 21D illustrates the result of an x-ray spectroscopy analysis on the media sample after the MOC test.

FIGS. 22A and 22B show top (FIG. 22A) and bottom (FIG. 22B) scanning electron micrographs of a cooling media sample of Munter's CELdek® treated with an oxidizing biocide according to an embodiment. FIG. 22C is a photograph of a portion of the media sample after an MOC test. FIG. 22D illustrates the result of an x-ray spectroscopy analysis on the media sample after the MOC test.

FIGS. 23A and 23B show top (FIG. 23A) and bottom (FIG. 23B) scanning electron micrographs of a cooling media sample of Munter's GLASdek® treated with an oxidizing biocide according to an embodiment. FIG. 23C is a photograph of a portion of the media sample after an MOC test. FIG. 23D illustrates the result of an x-ray spectroscopy analysis on the media sample after the MOC test.

FIGS. 24A and 24B show top (FIG. 24A) and bottom (FIG. 24B) scanning electron micrographs of a cooling media sample of Munter's CELdek® treated with an oxidizing biocide according to an embodiment. FIG. 24C is a photograph of a portion of the media sample after an MOC test. FIG. 24D illustrates the result of an x-ray spectroscopy analysis on the media sample after the MOC test.

FIGS. 25A and 23B show top (FIG. 25A) and bottom (FIG. 25B) scanning electron micrographs of a cooling media sample of Munter's GLASdek® treated with an oxidizing biocide according to an embodiment. FIG. 25C is a photograph of a portion of the media sample after an MOC test. FIG. 25D illustrates the result of an x-ray spectroscopy analysis on the media sample after the MOC test.

FIGS. 26A and 26B show top (FIG. 26A) and bottom (FIG. 26B) scanning electron micrographs of a cooling media sample of Munter's CELdek® treated with a non-oxidizing biocide according to an embodiment. FIG. 26C is a photograph of a portion of the media sample after an MOC test. FIG. 26D illustrates the result of an x-ray spectroscopy analysis on the media sample after the MOC test.

FIGS. 27A and 27B show top (FIG. 27A) and bottom (FIG. 27B) scanning electron micrographs of a cooling media sample of Munter's GLASdek® treated with a non-oxidizing biocide according to an embodiment. FIG. 27C is a photograph of a portion of the media sample after an MOC test. FIG. 27D illustrates the result of an x-ray spectroscopy analysis on the media sample after the MOC test.

FIGS. 28A and 28B show top (FIG. 28A) and bottom (FIG. 28B) scanning electron micrographs of a cooling media sample of Munter's CELdek® treated with a non-oxidizing biocide according to an embodiment. FIG. 28C is a photograph of a portion of the media sample after an MOC test. FIG. 28D illustrates the result of an x-ray spectroscopy analysis on the media sample after the MOC test.

FIGS. 29A and 29B show top (FIG. 29A) and bottom (FIG. 29B) scanning electron micrographs of a cooling media sample of Munter's GLASdek® treated with a non-oxidizing biocide according to an embodiment. FIG. 29C is a photograph of a portion of the media sample after an MOC test. FIG. 29D illustrates the result of an x-ray spectroscopy analysis on the media sample after the MOC test.

FIGS. 30A and 30B show top (FIG. 30A) and bottom (FIG. 30B) scanning electron micrographs of a cooling media sample of Munter's CELdek® treated with a biodispersant according to an embodiment. FIG. 30C is a photograph of a portion of the media sample after an MOC test. FIG. 30D illustrates the result of an x-ray spectroscopy analysis on the media sample after the MOC test.

FIGS. 31A and 31B show top (FIG. 31A) and bottom (FIG. 31B) scanning electron micrographs of a cooling media sample of Munter's GLASdek® treated with a biodispersant according to an embodiment. FIG. 31C is a photograph of a portion of the media sample after an MOC test. FIG. 31D illustrates the result of an x-ray spectroscopy analysis on the media sample after the MOC test.

FIGS. 32A and 32B show top (FIG. 32A) and bottom (FIG. 32B) scanning electron micrographs of a cooling media sample of Munter's CELdek® treated with a phosphonate according to an embodiment. FIG. 32C is a photograph of a portion of the media sample after an MOC test. FIG. 32D illustrates the result of an x-ray spectroscopy analysis on the media sample after the MOC test.

FIGS. 33A and 33B show top (FIG. 33A) and bottom (FIG. 33B) scanning electron micrographs of a cooling media sample of Munter's GLASdek® treated with a phosphonate according to an embodiment. FIG. 33C is a photograph of a portion of the media sample after an MOC test. FIG. 33D illustrates the result of an x-ray spectroscopy analysis on the media sample after the MOC test.

FIGS. 34A and 34B show top (FIG. 34A) and bottom (FIG. 34B) scanning electron micrographs of a cooling media sample of Munter's CELdek® treated with a phosphonate according to an embodiment. FIG. 34C is a photograph of a portion of the media sample after an MOC test. FIG. 34D illustrates the result of an x-ray spectroscopy analysis on the media sample after the MOC test.

FIGS. 35A and 35B show top (FIG. 35A) and bottom (FIG. 35B) scanning electron micrographs of a cooling media sample of Munter's GLASdek® treated with a phosphonate according to an embodiment. FIG. 35C is a photograph of a portion of the media sample after an MOC test. FIG. 35D illustrates the result of an x-ray spectroscopy analysis on the media sample after the MOC test.

FIGS. 36A and 36B show top (FIG. 36A) and bottom (FIG. 36B) scanning electron micrographs of a cooling media sample of Munter's CELdek® treated with an azole according to an embodiment. FIG. 36C is a photograph of a portion of the media sample after an MOC test. FIG. 36D illustrates the result of an x-ray spectroscopy analysis on the media sample after the MOC test.

FIGS. 37A and 37B show top (FIG. 37A) and bottom (FIG. 37B) scanning electron micrographs of a cooling media sample of Munter's GLASdek® treated with an azole according to an embodiment. FIG. 37C is a photograph of a portion of the media sample after an MOC test. FIG. 37D illustrates the result of an x-ray spectroscopy analysis on the media sample after the MOC test.

FIGS. 38A and 38 B show top (FIG. 38A) and bottom (FIG. 38B) scanning electron micrographs of a cooling media sample of Munter's CELdek® treated with a dispersant polymer according to an embodiment. FIG. 38C is a photograph of a portion of the media sample after an MOC test. FIG. 38D illustrates the result of an x-ray spectroscopy analysis on the media sample after the MOC test.

FIGS. 39A and 39B show top (FIG. 39A) and bottom (FIG. 39B) scanning electron micrographs of a cooling media sample of Munter's GLASdek® treated with a dispersant polymer according to an embodiment. FIG. 39C is a photograph of a portion of the media sample after an MOC test. FIG. 39D illustrates the result of an x-ray spectroscopy analysis on the media sample after the MOC test.

FIG. 40 shows results of a CaCO₃ scale inhibition performance evaluation according to an embodiment.

FIG. 41 shows results of a Ca₃(PO₄)₂ scale inhibition performance evaluation according to an embodiment.

### DETAILED DESCRIPTION

Disclosed embodiments employ a chemical treatment that contacts a surface of an adiabatic cooling medium in an evaporative cooling system. In embodiments, the adiabatic cooling medium may include a fill comprised of cellulose or silicon dioxide. The fill may include a material other than polyvinyl chloride, polypropylene, chlorinated polyvinylpropylene, polyethylene, and/or polyethylene terephthalate. The fill may also include an epoxy resin, silicone, cyanoacrylate, polyvinylacetate, polyester, vinyl ester, halogenated organophosphorus compound, acrylic polymer, vinyl-acrylic copolymer, styrene-butadiene copolymer, styrene-acrylonitrile-butadiene copolymer, vinyl ester-ethylene, and/or latex.

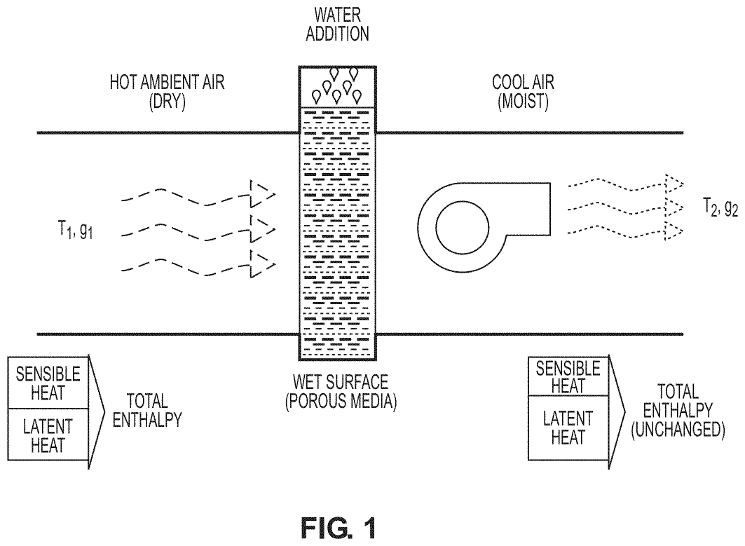

FIG. 1 illustrates an adiabatic cooling medium in an evaporative cooling system according to embodiments. As seen in FIG. 1, hot ambient air from the data center equipment having a temperature T₁ and mass g₁ flows through adiabatic cooling medium and is output as cool moist air having a temperature T₂ and mass g₂. The total enthalpy is unchanged with the reduction in sensible heat being compensated for by an increase in the latent heat, as seen in FIG. 1.

### The Chemical Treatment

According to embodiments, the chemical treatment is compatible with cooling media

Materials of Compatibility (MOC) to help improve performance and health of evaporative cooling systems and prolong the useful life of the cooling media and leads to customer savings in terms of water usage, and energy by maintaining high cycles of concentration for evaporative cooling systems, which further leads to reduced blowdown discharge to environment under regulatory limits. The disclosed chemical treatment is non-destructive and helps sustain microstructure of cooling media's MOC under extended exposure duration (e.g., 30 days or more) for a broad application dosage range. The disclosed chemical treatment also has superior efficiency in inhibiting mineral scale deposit and biofouling on cellulose based media under a broad range of application dosages.

The chemical treatment program can be applied in both liquid (in solution) and solid (compositional) forms to help customers improve their productivity and sustainability of cooling systems.

The chemical treatment may include phosphates and phosphonates including organic phosphonates. Preferably, the phosphonate is an organic phosphonate. The organic phosphonates may include, but are not limited to, 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), phosphinosuccinic oligomer (PSO), and mixtures thereof. The phosphonate of the chemical treatment may be present in the composition or solution in any suitable amount. For example, it may be present at the stage it is applied to the cooling media in a range of 5% to 100 wt %, 10% to 95 wt %, 20% to 90 wt %, 20% to 85 wt %, 30% to 70 wt %, 40% to 60 wt %, or 45% to 50 wt %, where all weight percentages are percent by weight of the total composition or solution.

The chemical treatment may include a dispersant polymer such as, for example, unsaturated carboxylic acid polymers. The carboxylic acid polymers may include, but are not limited to, polyacrylic acid, homo or co-polymaleic acid (synthesized from solvent and aqueous routes); acrylate/2-acrylamido-2-methylpropane sulfonic acid (AMPS) copolymers, acrylate/acrylamide copolymers, acrylate homopolymers, terpolymers of carboxylate/sulfonate/maleate, terpolymers of acrylic acid/AMPS, and mixtures thereof. The polymeric dispersant of the chemical treatment may be present in the composition or solution in any suitable amount. For example, it may be present at the stage it is applied to the cooling media in a range of 5% to 100 wt %, 10% to 95 wt %, 20% to 90 wt %, 20% to 85 wt %, 30% to 70 wt %, 40% to 60 wt %, or 45% to 50 wt %, where all weight percentages are percent by weight of the total composition or solution.

In preferred embodiments, the chemical treatment will include either or both of the phosphonate and dispersant polymer. In combination, phosphonates and dispersant polymers have been shown to exhibit synergistic effects. The phosphonate and dispersant polymer of the chemical treatment may be present in the composition or solution in combination in any suitable amount. For example, they may be present at the stage they is applied to the cooling media in a range of 5% to 100 wt %, 10% to 95 wt %, 20% to 90 wt %, 20% to 85 wt %, 30% to 70 wt %, 40% to 60 wt %, or 45% to 50 wt %, where all weight percentages are percent by weight of the total composition or solution.

Without intending to be bound by theory, it is believed that the chemical treatment functions by phosphonates chelating with metal salts to prevent fouling on surface, and/or dispersant polymers dispersing metal salts or other contaminants to enhancing flushing of the salts or contaminates out of the system and/or to facilitate function of the phosphonates.

Additional elements may be included in the chemical treatment. For example, the chemical treatment may include scale inhibitors or cleaners such chelanting agents that are usually needed for dirty systems. Biocides and/or tracers may also be included.

The scale inhibitor may include, for example, unsaturated carboxylic acid polymers such as polyacrylic acid, homo or co-polymaleic acid (synthesized from solvent and aqueous routes); acrylate/2-acrylamido-2-methylpropane sulfonic acid (APMS) copolymers, acrylate/acrylamide copolymers, acrylate homopolymers, terpolymers of carboxylate/sulfonate/maleate, terpolymers of acrylic acid/AMPS; phosphonates and phosphinates such as 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), phosphinosuccinic oligomer (PSO); salts of molybdenum and tungsten including, for example, nitrates and nitrites; amines such as N,N-diethylhydroxylamine (DEHA), diethyl amino ethanol (DEAE), dimethylethanolamine, (DMAE), cyclohexylamine, morpholine, monoethanolamine (MEA), a biocide, and combinations thereof. The scale inhibitor of the chemical treatment may be present in the composition or solution in any suitable amount. For example, it may be present at the stage it is applied to the cooling media in a range of 5% to 100 wt %, 10% to 95 wt %, 20% to 90 wt %, 20% to 85 wt %, 30% to 70 wt %, 40% to 60 wt %, or 45% to 50 wt %, where all weight percentages are percent by weight of the total composition or solution.

The chelating agent may include, for example, citric acid, azole based copper corrosion inhibitors such as benzotriazole and 2-Butenedioic acid (Z), halogenated azoles and their derivatives, scale inhibitors and dispersants selected from the group consisting one or more of unsaturated carboxylic acid polymers such as polyacrylic acid, homo or co-polymaleic acid (synthesized from solvent and aqueous routes); acrylate/2-acrylamido-2-methylpropane sulfonic acid (APMS) copolymers, acrylate/acrylamide copolymers, acrylate homopolymers, terpolymers of carboxylate/sulfonate/maleate, terpolymers of acrylic acid/AMPS; phosphonates and phosphinates such as 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), phosphinosuccinie oligomer (PSO); salts of molybdenum and tungsten including, for example, nitrates and nitrites; amines such as N,N-diethylhydroxylamine (DEHA), diethyl amino ethanol (DEAE), dimethylethanolamine (DMAE), cyclohexylamine, morpholine, monoethanolamine (MEA), a biocide, and combinations thereof. The chelating agent of the chemical treatment may be present in the composition or solution in any suitable amount. For example, it may be present at the stage it is applied to the cooling media in a range of 5% to 100 wt %, 10% to 95 wt %, 20% to 90 wt %, 250% to 85 wt %, 30% to 70 wt %, 40% to 60 wt %, or 45% to 50 wt %, where all weight percentages are percent by weight of the total composition or solution.

The biocide may include, for example, an oxidizing or non-oxidizing biocide. The biocide may be any commercial oxidizing biocides generally governed by the Environmental Protection Agency's (EPA) Toxic Substances Control Act (TSCA). As will be understood by one of ordinary skill in the art, any suitable oxidizing biocide within acceptable EPA-designated concentrations are contemplated by this disclosure. For example, in embodiments, the oxidizing biocide may sodium hypochlorite (NaOCl) (bleach), chlorine gas (Cl₂), and bleaching powder or calcium hypochlorite (Ca(OCl)₂). The concentration of oxidizing biocide contemplated by this disclosure is also not particularly limited. For purposes of this disclosure, the oxidizing biocide will be described with reference to industrial bleach or sodium hypochlorite which may be in the range of 10% to 20% solution, and usually 12%, user-dilution notwithstanding. The biocide of the chemical treatment may be present in the composition or solution in any suitable amount. For example, it may be present at the stage it is applied to the cooling media in a range of 5% to 100 wt %, 10% to 95 wt %, 20% to 90 wt %, 20% to 85 wt %, 30% to 70 wt %, 40% to 60 wt %, or 45% to 50 wt %, where all weight percentages are percent by weight of the total composition or solution.

The tracer may be any suitable element including, but not limited to, fluorescent active components and may be present in any suitable amount.

### Application of the Treatment Chemistry

With reference to FIG. 1, the disclosed chemical treatment can be applied directly to the cooling media via the water inflow. The chemical treatment may also be separately applied to the cellulose cooing media itself by, for example, coating a solid form of the media with the chemical treatment or as a membrane containing material itself.

In liquid form, the chemical treatment may be infused through a pump. When applied in liquid form, the chemical treatment may be dissolved and eluted through media membrane. When applied in solid form, the chemical treatment may be dissolved and then eluted through media membrane. The liquid or dissolved solid may elute through the membrane at any suitable rate that allows the chemical treatment to exist in the circulating water. For example, the rate may be in a range of 0.01 to 1000 ppm, 0.1 to 500 ppm, 1 to 100 ppm, or 1 to 50 ppm.

When additional cleaning elements (e.g., chelating agents and biocides, as discussed herein) are included in the chemical treatment for treatment of particularly dirty systems, these elements are usually applied for in a range of 28 to 48 hours.

Methods for infusing the chemical treatment, including controlling the flow of the infusion, may include a multi-valve system or the like, as would be understood by one of ordinary skill in the art. Moreover control of the treatment while in the system is not particularly limited. Infusion control, including frequency, duration, concentrations, dosing amounts, dosing types and the like, may be controlled manually or automatically through, for example, an algorithm or a computer executable medium, such as a CPU. These controls may further be implemented with data and history-driven machine-learning capabilities and feedback loops for automatically adapting treatment regimens to system and media surface environmental conditions.

The chemical treatment application can be continuous, intermittent or periodic. For example, the treatment may occur in a range of 10% or more, 20% or more, 30% or more, 40% or more, or 50% or more of the operational time. When the phosphonates and dispersant polymers are added in combination, the phosphonates can be added to the water stream apart from the dispersant polymers, or each can be added separately.

The treatment may stay in the system for a full cycle (i.e., through the cooling media) or several cycles. For example, the cycles of concentration may be in the range of 1 to 100, 1 to 75, 3 to 50, or 5 and 40 cycles. The chemical treatment is then gradually removed from the system with the process water in the system, for example, through known blowdown removal techniques in evaporative cooling systems.

During the application of the chemical treatment, the conductivity of the circulating water may exceed 5000 μS/cm and be as high as 10,000 μS/cm. The total dissolved solids (TDS) of the circulating water may exceed 2500 ppm and be as high as 10,000 ppm.

Disclosed methods may be employed while the evaporative system implementing the chemical treatment process is online or offline. As used herein, the term “online” refers to application of the chemical treatment while the system is operational and evaporative cooling is happening as opposed to being “offline” when operation ceases.

### Treatment Chemistry Feed Automation and Control

Using the methods described herein, chemical treatments are able to be controlled, i.e., adjusted and optimized, while the system is online, thereby increasing overall efficiency and reducing costs. A feed system feeds the chemical treatments into the cooling media. According to embodiments, chemical treatment feed rates can be precisely and accurately controlled.

The dosage and rate control plan for the application of the chemical treatments will be dependent upon the specific contents of the chemical treatments, the control plan and system operating conditions. According to the disclosed methods, the dosage amounts and rates can be developed for each chemical treatment applied, to thereby allow for the change in dosage amounts and rates.

A control feed architecture according to embodiments may include at least one circulation pump for circulating the fermentation fluid flow through the system and at least one chemical treatment solution pump for feeding the chemical treatment into the cooling media or process stream of the evaporative cooling system. Multiple circulation pumps and chemical treatment pumps may be provided in order to accommodate required volumes of fluid running through the system. A distributed control system (DCS) controller may control the operation of these pumps based on demand driven by various system parameters, e.g., operational load. The DCS controller controls the overall operation of the facility and is where the plant instrumentation sends its data, and may include, for example, tens of thousands of data points. The architecture may further include a data capture panel for receiving operations input and providing the DCS controller with the appropriate instructions for controlling the operation of the pumps.

The proper chemical treatment dosage and rate can be adjusted real-time using recorded parameters. Once the dosage amounts and rates are calculated, these schemes may be stored in the storage for historical purposes. The schemes are then accessed by the DCS controller when appropriate and applied to the evaporative cooling system via the control feed architecture. The control feed architecture adjusts the amount and/or rate of the chemical treatment by, for example, calculating the ml/min set point to control and adjust the various chemical feed pumps to control flow from the chemical treatment source to the evaporative cooling system. The dosage schemes for each specific chemical treatment are optimized in this manner.

Additionally, the programmable logic behind the dosing and application rate can be refined in the field in response to real-time real-world conditions and performance at the site. And adjustments to dosing and application rate can be made virtually instantaneously. As a result, the disclosed embodiments will provide real-time and more effective control management compared to conventional processes by improving the overall reliability, efficiency, and economic productivity of the evaporative cooling system.

Embodiments may further include machine learning algorithms implemented on the disclosed controllers for executing the disclosed functions in a predictive manner. For example, the machine learning algorithms may be used to establish historical patterns to predict future feed needs based on any one or more parameters that may include. Outputs of the predictive logic controllers may be connected to external reporting and analysis sites such as an inventory control device.

The programmatic tools used in developing the disclosed machine learning algorithms are not particularly limited and may include, but are not limited to, open source tools, rule engines such as Hadoop®, programming languages including SAS®, SQL, R and Python and various relational database architectures.

Each of the disclosed controllers may be a specialized computer(s) or processing system(s) that may implement machine learning algorithms according to disclosed embodiments. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the disclosed embodiments may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. The processor may include a module that performs the methods described herein. The module may be programmed into the integrated circuits of the processor, or loaded from memory, storage device, or network or combinations thereof.

### EXAMPLES

### Experiment 1

The following examples were conducted in a laboratory setting using cooling media samples of Munter's CELdek® and GLASdek®. Various chemical treatment solutions were tested as follows in Tables 1 and 2.

TABLE 1
Methodology.

| Scale Inhibitor | Biocide | Cleaners |
|---|---|---|
| Place media sample into beaker with | Place media sample into beaker with | Place media sample into beaker with |
| associated chemistry blend. Record date and | associated chemistry blend. Record date and | associated chemistry blend. Record date and |
| time of start of the media sample incubation | time of start of the media sample incubation | time of start of the media sample incubation. [symbol] |
| at 78.8 F. | at 78.8° F. [symbol] | |
| Chemical solution should be replaced weekly | Biocide solutions should be replaced every ~24 | Incubate for 6 hours at ambient temperature. |
| at a minimum. Confirm actives levels are still | hours during the week. If weekends or lab | After 6 hours of exposure, replace with new |
| within target range. If they have dropped | shifts result in missed solution replacement, | solution and continue incubation overnight |
| more than 10%, increase frequency of solution | note this on the data collection. | (18 hours). |
| replacement. [symbol] | | |
| On day 30 of incubation remove media sample | On day 30 of incubation remove media sample | Remove media sample, air dry for 2 hours and |
| and shake excess fluid. Allow sample to sit on | and shake excess fluid. Allow sample to sit on | take final weight. [symbol] |
| dry surface for 1 minute. Record End Wet | dry surface for 1 minute. Record End Wet | |
| Weight of media sample. [symbol] | Weight of media sample. [symbol] | |

TABLE 2
MOC Study.

| | | | | | | | Concentrated | Incubation | |
|---|---|---|---|---|---|---|---|---|---|
| | Liquid | | | | Concentrated Dose | | Dose As | Water | Corresponding |
| Sample | or Dry | Primary Active | Normal Usage Dose | | As Product | | Actives | Temp (F.) | FIGS. |
| Baseline | — | — | — | | — | | — | — | 2A-3D |
| Control | Liquid | Water (used with | — | | N/A | | — | 78.8 | 4A-5D |
| | | all chemistry) | | | | | | | |
| Comp. | Liquid | Sulfuric Acid | | | 20% by volume | | — | 78.8 | 6A-7D |
| Example 1 | | | | | | | | | |
| Example 1 | Liquid | Cleaner 1 | 60-200 | | 400 | ppm | — | — | 8A-9D |
| Example 2 | Liquid | Cleaner 2 | 500-5000 | ppm | 5000 | ppm | — | — | 10A-11D |
| Example 3 | Liquid | Cleaner 3 | 1000-4000 | ppm | 4000 | ppm | — | — | 12A-13D |
| Example 4 | Liquid | Cleaner 4 | 1-10% by volume | | 20% by volume | | — | — | 14A-15D |
| Example 5 | Liquid | Cleaner 5 | 10-30% by volume | | 60% by volume | | — | — | 16A-17D |
| Example 6 | Liquid | Cleaner 6 | 1-10% by volume | | 20% by volume | | — | — | 18A-19D |
| Example 7 | Liquid | Cleaner 7 | | | | | — | — | 20A-21D |
| Example 8 | Dry | Oxidizing | 2-20 | ppm | .0032 | lbs/gallon | 20 ppm Free | 78.8 | 22A-23D |
| | | Biocide 1 | | | | | Halogen | | |
| Example 9 | Liquid | Oxidizing | 90 ppm as product | | 1800 | ppm | 20 ppm Free | 78.8 | 24A-25D |
| | | Biocide 2 | | | | | Halogen | | |
| Example 10 | Liquid | Non-Oxidizing | 20-50 | ppm | 500 | ppm | — | 78.8 | 26A-27D |
| | | Biocide 1 | | | | | | | |
| Example 11 | Liquid | Non-Oxidizing | 80-240 | ppm | 800 | ppm | — | 78.8 | 28A-29D |
| | | Biocide 2 | | | | | | | |
| Example 12 | Liquid | Biodispersant | 50 ppm Active | | | | — | 78.8 | 30A-31D |
| Example 13 | Liquid | Phosphonate 1 | 12 ppm as active | | 270 | ppm | 120 ppm | 78.8 | 32A-33D |
| Example 14 | Liquid | Phosphonate 2 | 12 ppm as active | | 220 | ppm | 120 ppm | 78.8 | 34A-35D |
| Example 15 | Liquid | Azole | 3-6 | ppm | 150 | ppm | 60 ppm | 78.8 | 36A-37D |
| Example 16 | Liquid | Dispersant | 10 | ppm | 100 | ppm | — | 78.8 | 38A-39D |
| | | Polymer | | | | | | | |

### Baseline Example

Untreated cooling media samples of Munter's CELdek® and Munter's GLASdek® were examined as a baseline analysis.

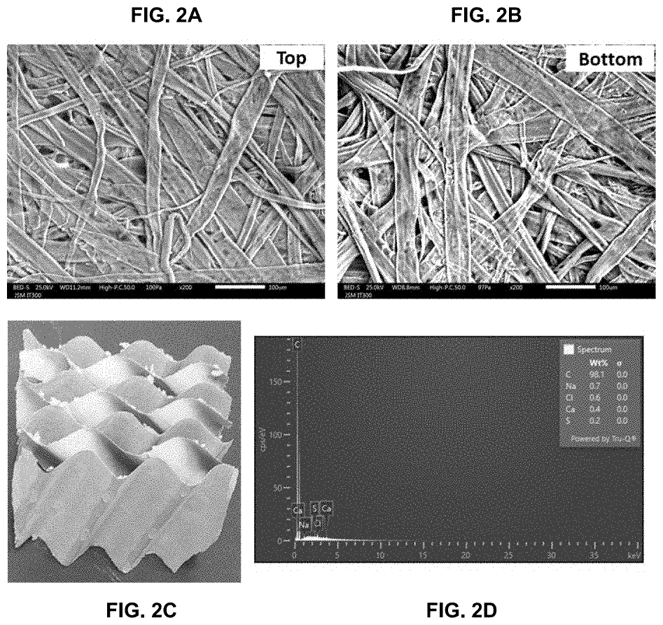

FIGS. 2A and 2B show top (FIG. 2A) and bottom (FIG. 2B) scanning electron micrographs of untreated cooling media samples of Munter's CELdek®. FIG. 2C is a photograph of a portion of the media sample. FIG. 2D illustrates the result of an x-ray spectroscopy analysis on the media sample.

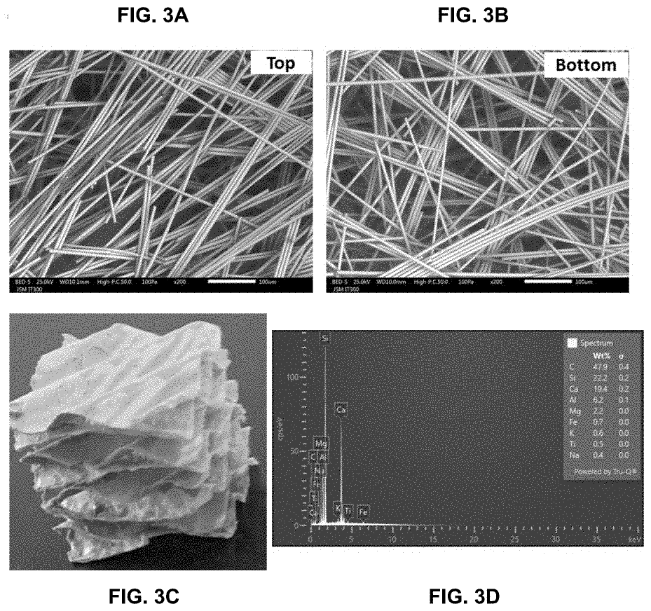

FIGS. 3A and 3B show top (FIG. 3A) and bottom (FIG. 3B) scanning electron micrographs of untreated cooling media samples of Munter's GLASdek®. FIG. 3C is a photograph of a portion of the media sample. FIG. 3D illustrates the result of an x-ray spectroscopy analysis on the media sample.

### Control Example

Cooling media samples of Munter's CELdek® and Munter's GLASdek® were treated with water and placed into a beaker according to the specifications in Table 1. On day 30 of incubation, the media samples were removed and the excess fluid was shaken off. The samples were allowed to sit on a dry surface for 1 minute and then examined as a control group.

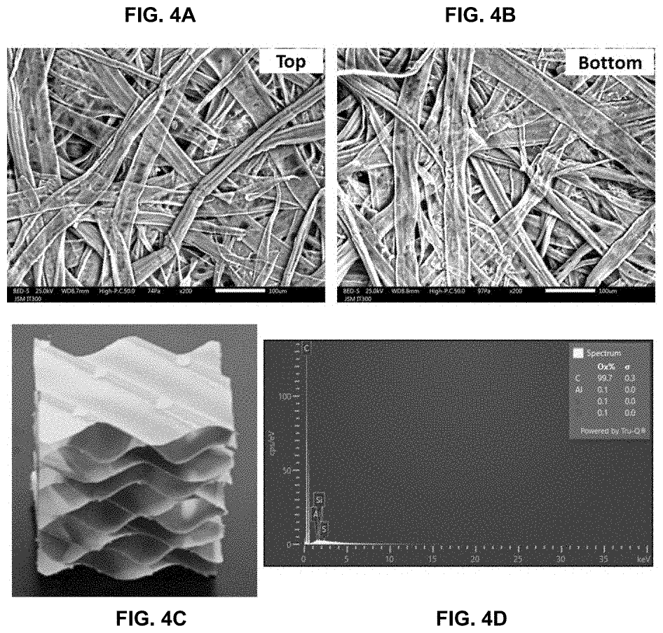

FIGS. 4A and 4B show top (FIG. 4A) and bottom (FIG. 4B) scanning electron micrographs of cooling media samples of Munter's CELdek® treated with the water. FIG. 4C is a photograph of a portion of the media sample after the MOC test. FIG. 4D illustrates the result of an x-ray spectroscopy analysis on the media sample after the MOC test.

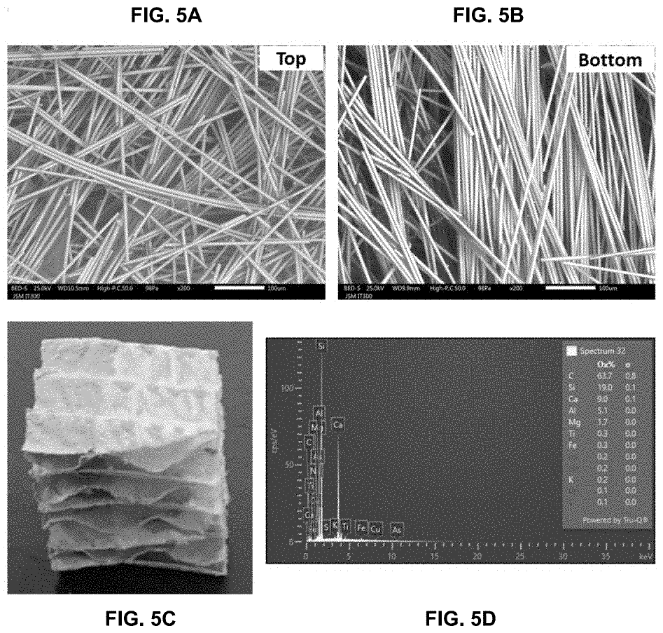

FIGS. 5A and 5B show top (FIG. 5A) and bottom (FIG. 5B) scanning electron micrographs of cooling media samples of Munter's GLASdek® treated with the water. FIG. 5C is a photograph of a portion of the media sample after an MOC test. FIG. 5D illustrates the result of an x-ray spectroscopy analysis on the media sample after the MOC test.

### Comparative Example 1

Cooling media samples of Munter's CELdek® and Munter's GLASdek® were treated with sulfuric acid and placed into a beaker according to the specifications in Table 1. On day 30 of incubation, the media samples were removed and the excess fluid was shaken off. The samples were allowed to sit on a dry surface for 1 minute and then examined as a negative control group.

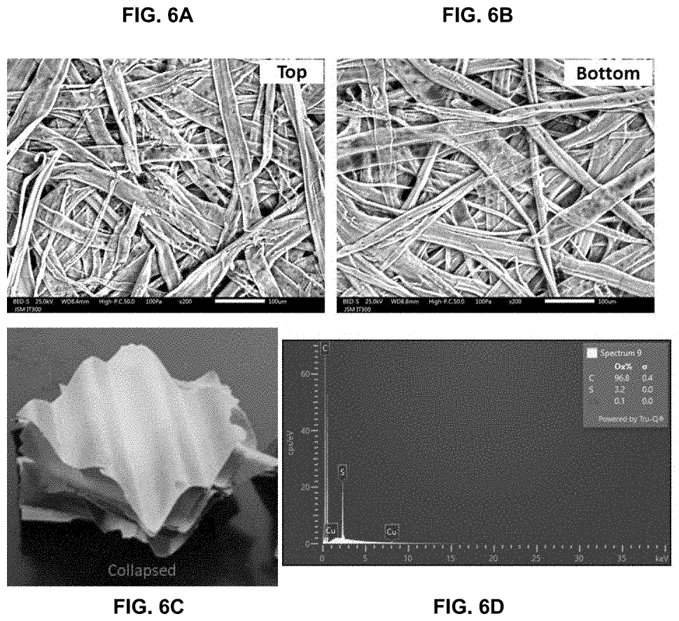

FIGS. 6A and 6B show top (FIG. 6A) and bottom (FIG. 6B) scanning electron micrographs of cooling media samples of Munter's CELdek® treated with the sulfuric acid. FIG. 6C is a photograph of a portion of the media sample after an MOC test. FIG. 6D illustrates the result of an x-ray spectroscopy analysis on the media sample after the MOC test.

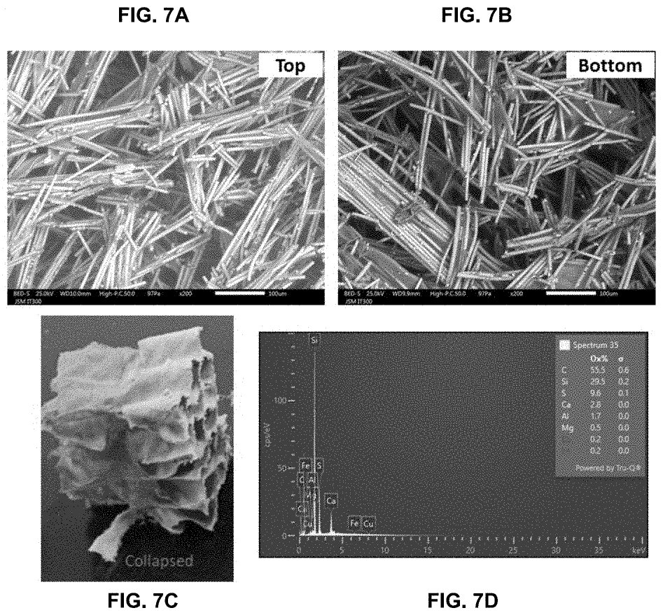

FIGS. 7A and 7B show top (FIG. 7A) and bottom (FIG. 7B) scanning electron micrographs of cooling media samples of Munter's GLASdek® treated with the sulfuric acid. FIG. 7C is a photograph of a portion of the media sample after an MOC test. FIG. 7D illustrates the result of an x-ray spectroscopy analysis on the media sample after the MOC test.

### Example 1

Cooling media samples of Munter's CELdek® and Munter's GLASdek® were treated with a cleaner according to the cleaner methodology in Table 1 above.

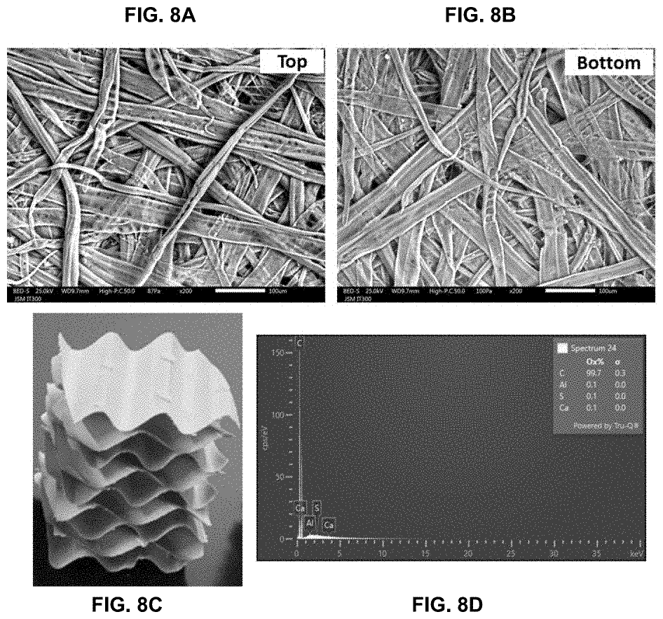

FIGS. 8A and 8B show top (FIG. 8A) and bottom (FIG. 8B) scanning electron micrographs of a cooling media sample of Munter's CELdek® treated with a cleaning sample according to an embodiment. FIG. 8C is a photograph of a portion of the media sample after an MOC test. FIG. 8D illustrates the result of an x-ray spectroscopy analysis on the media sample after the MOC test.

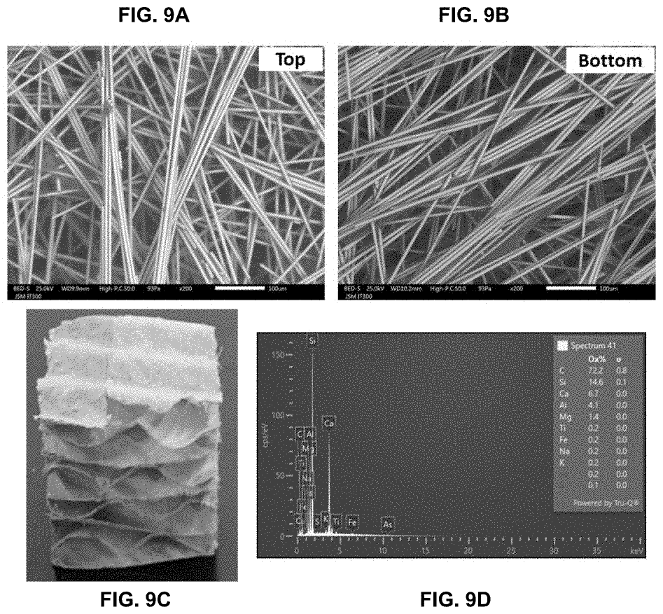

FIGS. 9A and 9B show top (FIG. 9A) and bottom (FIG. 9B) scanning electron micrographs of a cooling media sample of Munter's GLASdek® treated with a cleaning sample according to an embodiment. FIG. 9C is a photograph of a portion of the media sample after an MOC test. FIG. 9D illustrates the result of an x-ray spectroscopy analysis on the media sample after the MOC test.

### Example 1

Cooling media samples of Munter's CELdek® and Munter's GLASdek® were treated with a cleaner according to the cleaner methodology in Table 1 above.

FIGS. 8A and 8B show top (FIG. 8A) and bottom (FIG. 8B) scanning electron micrographs of a cooling media sample of Munter's CELdek® treated with a cleaning sample according to an embodiment. FIG. 8C is a photograph of a portion of the media sample after an MOC test. FIG. 8D illustrates the result of an x-ray spectroscopy analysis on the media sample after the MOC test.

FIGS. 9A and 9B show top (FIG. 9A) and bottom (FIG. 9B) scanning electron micrographs of a cooling media sample of Munter's GLASdek® treated with a cleaning sample according to an embodiment. FIG. 9C is a photograph of a portion of the media sample after an MOC test. FIG. 9D illustrates the result of an x-ray spectroscopy analysis on the media sample after the MOC test.

### Example 2

Cooling media samples of Munter's CELdek® and Munter's GLASdek® were treated with a cleaner according to the cleaner methodology in Table 1 above.

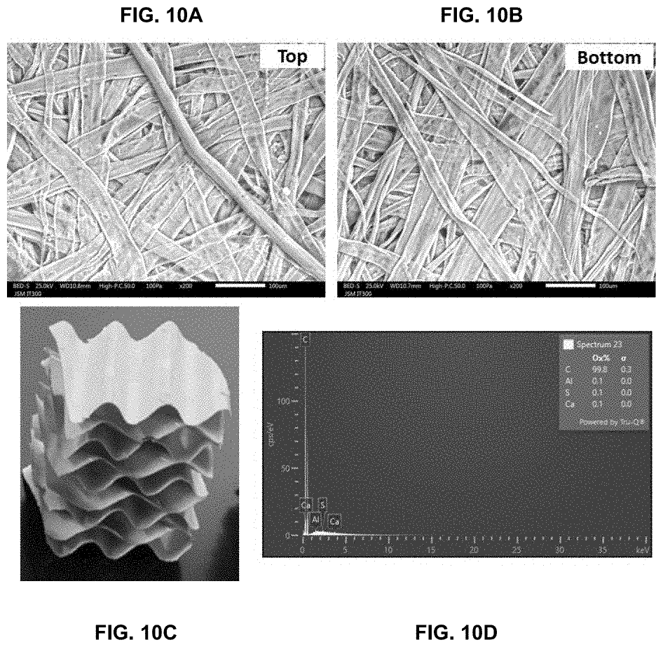

FIGS. 10A and 10B show top (FIG. 10A) and bottom (FIG. 10B) scanning electron micrographs of a cooling media sample of Munter's CELdek® treated with a cleaning sample according to an embodiment. FIG. 10C is a photograph of a portion of the media sample after an MOC test. FIG. 10D illustrates the result of an x-ray spectroscopy analysis on the media sample after the MOC test.

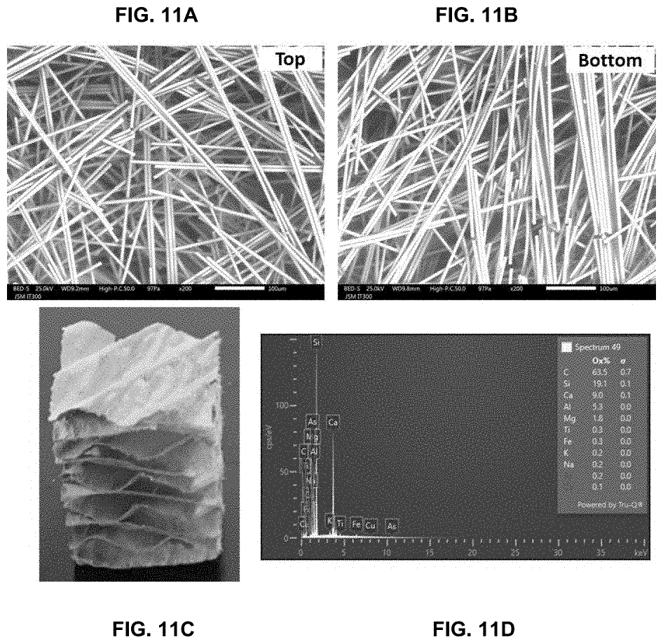

FIGS. 11A and 11B show top (FIG. 11A) and bottom (FIG. 11B) scanning electron micrographs of a cooling media sample of Munter's GLASdek® treated with a cleaning sample according to an embodiment. FIG. 11C is a photograph of a portion of the media sample after an MOC test. FIG. 11D illustrates the result of an x-ray spectroscopy analysis on the media sample after the MOC test.

### Example 3

Cooling media samples of Munter's CELdek® and Munter's GLASdek® were treated with a cleaner according to the cleaner methodology in Table 1 above.

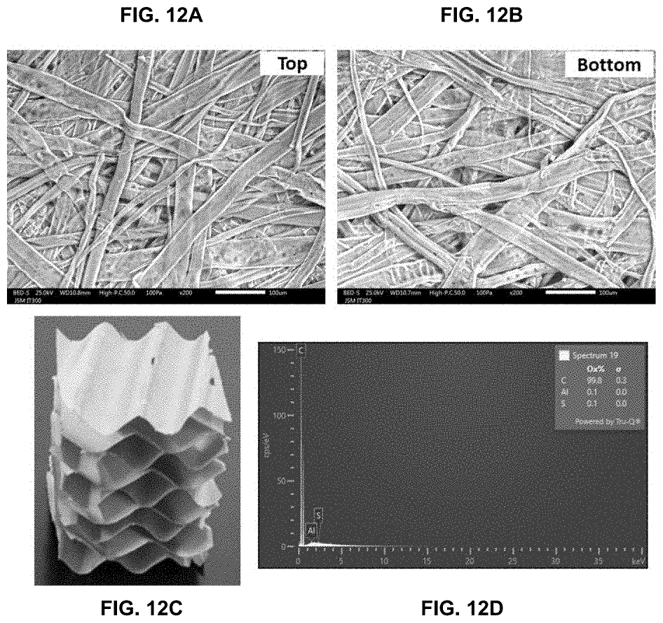

FIGS. 12A and 12B show top (FIG. 12A) and bottom (FIG. 12B) scanning electron micrographs of a cooling media sample of Munter's CELdek® treated with a cleaning sample according to an embodiment. FIG. 12C is a photograph of a portion of the media sample after an MOC test. FIG. 12D illustrates the result of an x-ray spectroscopy analysis on the media sample after the MOC test.

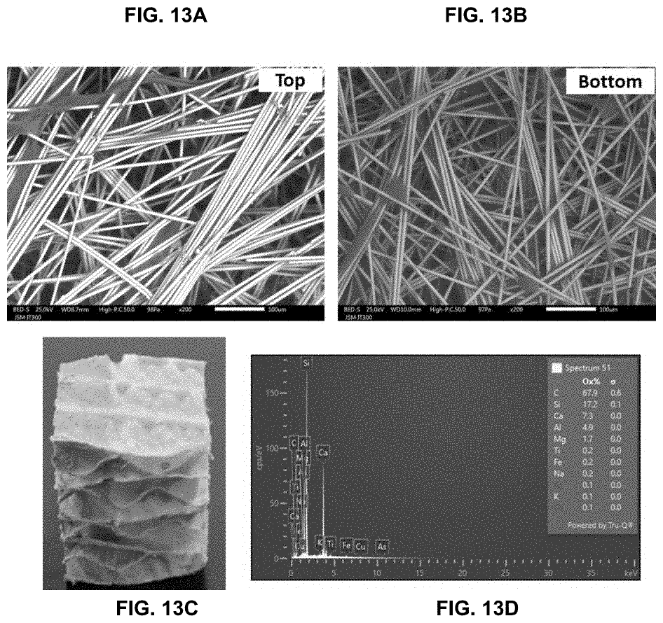

FIGS. 13A and 13B show top (FIG. 13A) and bottom (FIG. 13B) scanning electron micrographs of a cooling media sample of Munter's GLASdek® treated with a cleaning sample according to an embodiment. FIG. 13C is a photograph of a portion of the media sample after an MOC test. FIG. 13D illustrates the result of an x-ray spectroscopy analysis on the media sample after the MOC test.

### Example 4

Cooling media samples of Munter's CELdek® and Munter's GLASdek® were treated with a cleaner according to the cleaner methodology in Table 1 above.

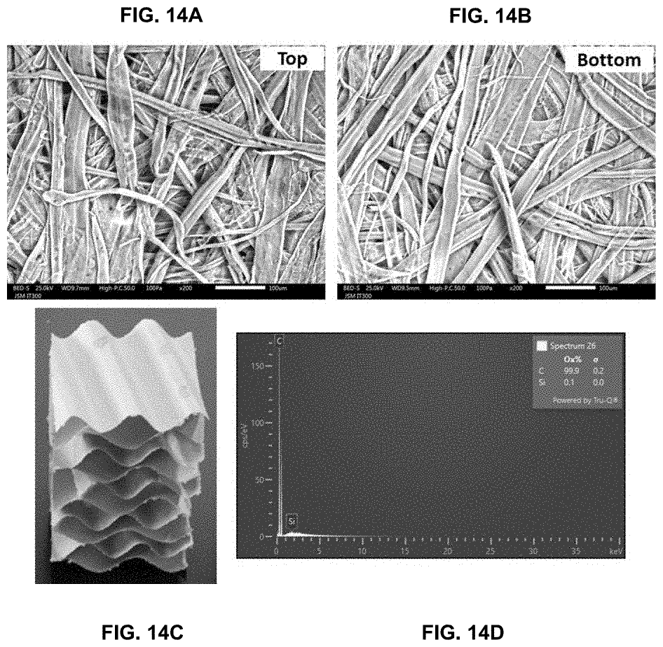

FIGS. 14A and 14B show top (FIG. 14A) and bottom (FIG. 14B) scanning electron micrographs of a cooling media sample of Munter's CELdek® treated with a cleaning sample according to an embodiment. FIG. 14C is a photograph of a portion of the media sample after an MOC test. FIG. 14D illustrates the result of an x-ray spectroscopy analysis on the media sample after the MOC test.

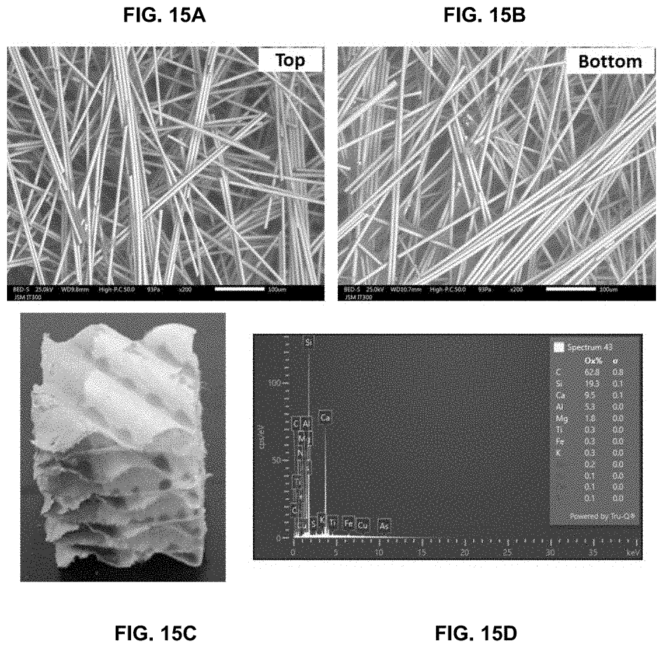

FIGS. 15A and 15B show top (FIG. 15A) and bottom (FIG. 15B) scanning electron micrographs of cooling media sample of Munter's GLASdek® treated with a cleaning sample according to an embodiment. FIG. 15C is a photograph of a portion of the media sample after an MOC test. FIG. 15D illustrates the result of an x-ray spectroscopy analysis on the media sample after the MOC test.

### Example 5

Cooling media samples of Munter's CELdek® and Munter's GLASdek® were treated with a cleaner according to the cleaner methodology in Table 1 above.

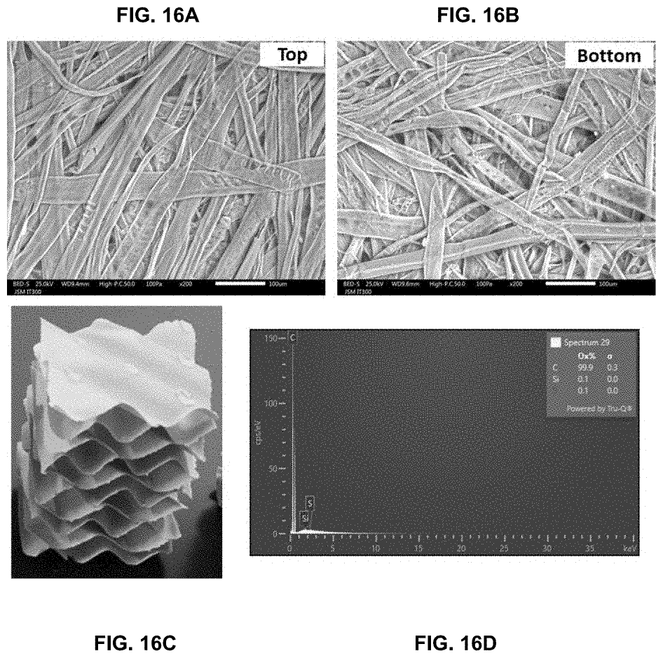

FIGS. 16A and 16B show top (FIG. 16A) and bottom (FIG. 16B) scanning electron micrographs of a cooling media sample of Munter's CELdek® treated with a cleaning sample according to an embodiment. FIG. 16C is a photograph of a portion of the media sample after an MOC test. FIG. 16D illustrates the result of an x-ray spectroscopy analysis on the media sample after the MOC test.

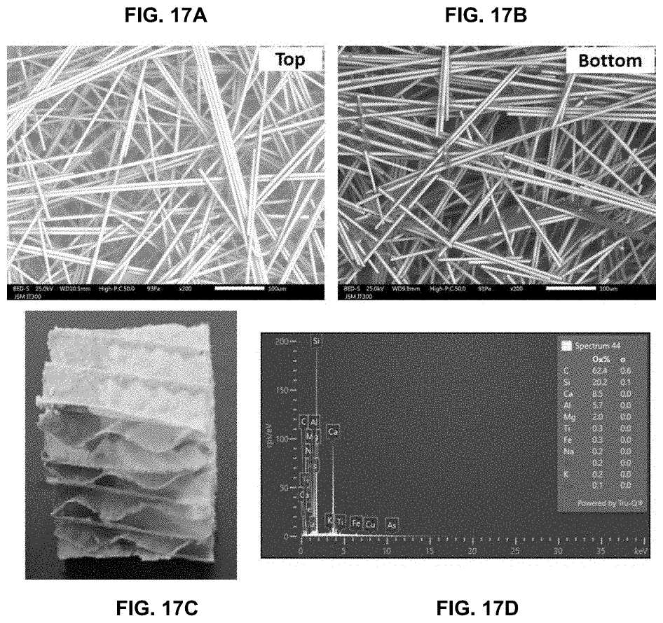

FIGS. 17A and 17B show top (FIG. 17A) and bottom (FIG. 17B) scanning electron micrographs of a cooling media sample of Munter's GLASdek® treated with a cleaning sample according to an embodiment. FIG. 17C is a photograph of a portion of the media sample after an MOC test. FIG. 17D illustrates the result of an x-ray spectroscopy analysis on the media sample after the MOC test.

### Example 6

Cooling media samples of Munter's CELdek® and Munter's GLASdek® were treated with a cleaner according to the cleaner methodology in Table 1 above.

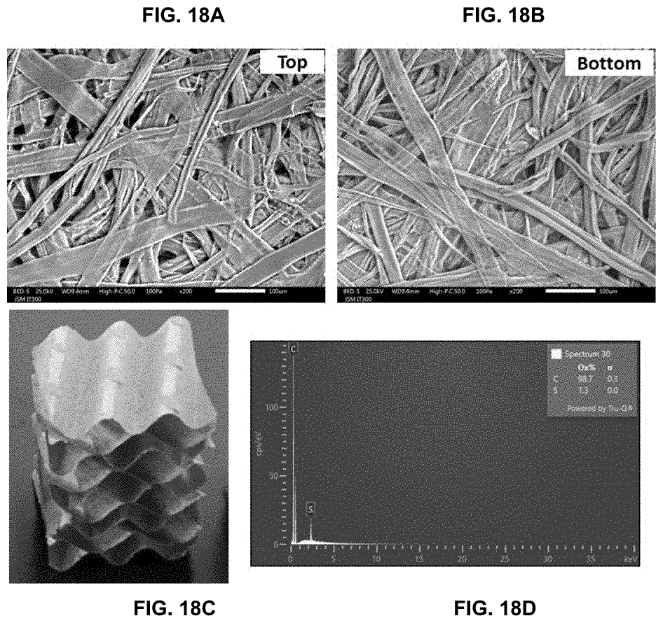

FIGS. 18A and 18B show top (FIG. 18A) and bottom (FIG. 18B) scanning electron micrographs of a cooling media sample of Munter's CELdek® treated with a cleaning sample according to an embodiment. FIG. 18C is a photograph of a portion of the media sample after an MOC test. FIG. 18D illustrates the result of an x-ray spectroscopy analysis on the media sample after the MOC test.

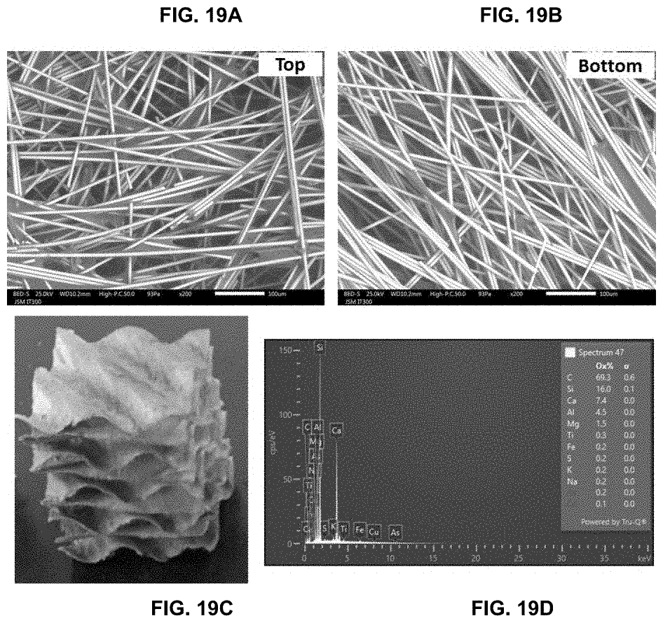

FIGS. 19A and 19B show top (FIG. 19A) and bottom (FIG. 19B) scanning electron micrographs of a cooling media sample of Munter's GLASdek® treated with a cleaning sample according to an embodiment. FIG. 19C is a photograph of a portion of the media sample after an MOC test. FIG. 19D illustrates the result of an x-ray spectroscopy analysis on the media sample after the MOC test.

### Example 7

Cooling media samples of Munter's CELdek® and Munter's GLASdek® were treated with a cleaner according to the cleaner methodology in Table 1 above.

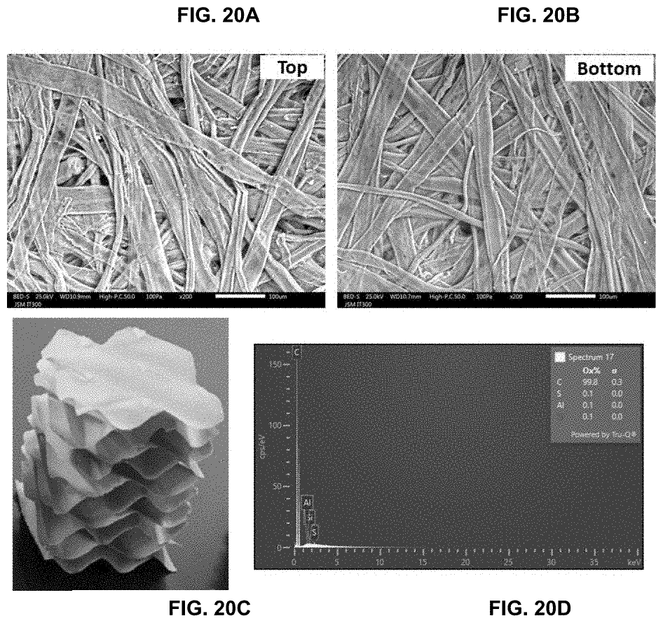

FIGS. 20A and 20B show top (FIG. 20A) and bottom (FIG. 20B) scanning electron micrographs of a cooling media sample of Munter's CELdek® treated with a cleaning sample according to an embodiment. FIG. 20C is a photograph of a portion of the media sample after an MOC test. FIG. 20D illustrates the result of an x-ray spectroscopy analysis on the media sample after the MOC test.

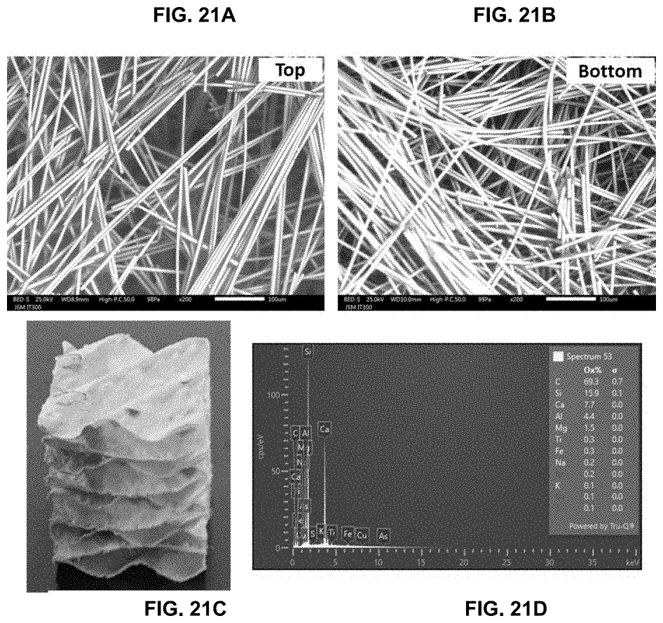

FIGS. 21A and 21B show top (FIG. 21A) and bottom (FIG. 21B) scanning electron micrographs of a cooling media sample of Munter's GLASdek® treated with a cleaning sample according to an embodiment. FIG. 21C is a photograph of a portion of the media sample after an MOC test. FIG. 21D illustrates the result of an x-ray spectroscopy analysis on the media sample after the MOC test.

### Example 8

Cooling media samples of Munter's CELdek® and Munter's GLASdek® were treated with an oxidizing biocide according to the biocide methodology in Table 1 above.

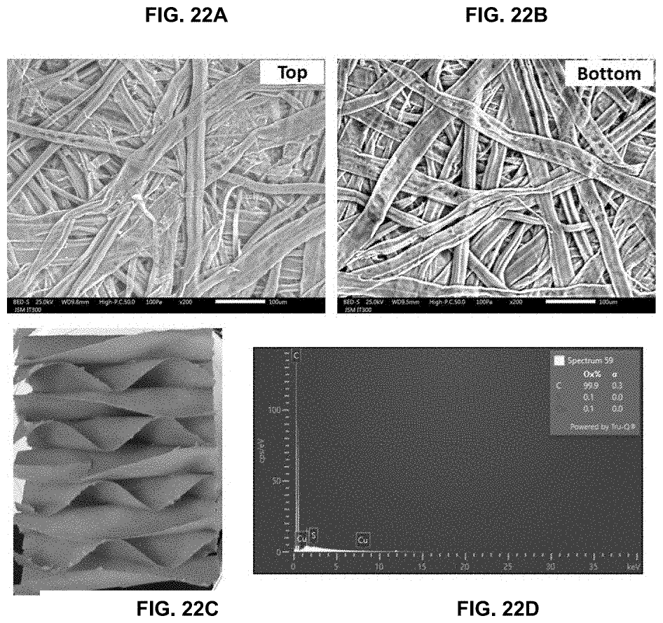

FIGS. 22A and 22B show top (FIG. 22A) and bottom (FIG. 22B) scanning electron micrographs of a cooling media sample of Munter's CELdek® treated with an oxidizing biocide according to an embodiment. FIG. 22C is a photograph of a portion of the media sample after an MOC test. FIG. 22D illustrates the result of an x-ray spectroscopy analysis on the media sample after the MOC test.

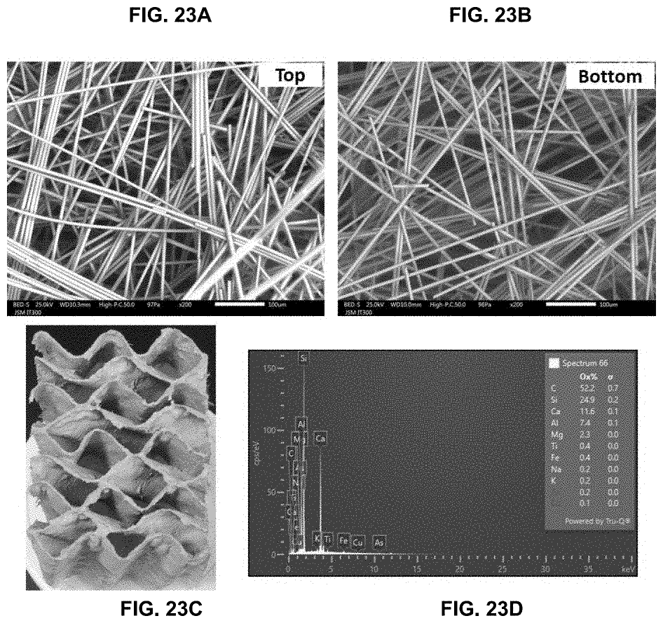

FIGS. 23A and 23B show top (FIG. 23A) and bottom (FIG. 23B) scanning electron micrographs of a cooling media sample of Munter's GLASdek® treated with an oxidizing biocide according to an embodiment. FIG. 23C is a photograph of a portion of the media sample after an MOC test. FIG. 23D illustrates the result of an x-ray spectroscopy analysis on the media sample after the MOC test.

### Example 9

Cooling media samples of Munter's CELdek® and Munter's GLASdek® were treated with an oxidizing biocide according to the biocide methodology in Table 1 above.

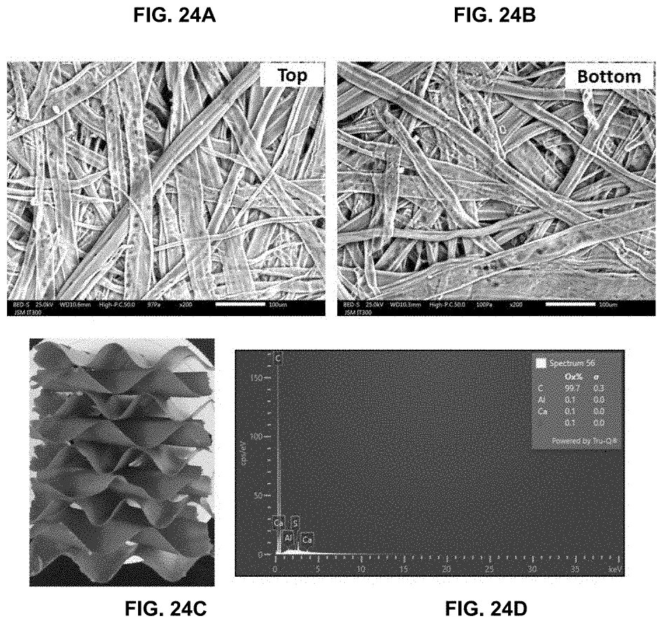

FIGS. 24A and 24B show top (FIG. 24A) and bottom (FIG. 24B) scanning electron micrographs of a cooling media sample of Munter's CELdek® treated with an oxidizing biocide according to an embodiment. FIG. 24C is a photograph of a portion of the media sample after an MOC test. FIG. 24D illustrates the result of an x-ray spectroscopy analysis on the media sample after the MOC test.

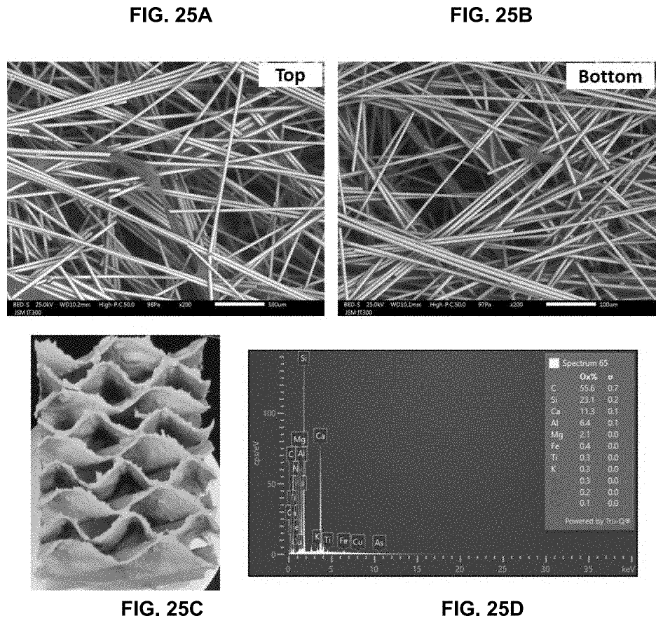

FIGS. 25A and 23B show top (FIG. 25A) and bottom (FIG. 25B) scanning electron micrographs of a cooling media sample of Munter's GLASdek® treated with an oxidizing biocide according to an embodiment. FIG. 25C is a photograph of a portion of the media sample after an MOC test. FIG. 25D illustrates the result of an x-ray spectroscopy analysis on the media sample after the MOC test.

### Example 10

Cooling media samples of Munter's CELdek® and Munter's GLASdek® were treated with a non-oxidizing biocide according to the biocide methodology in Table 1 above.

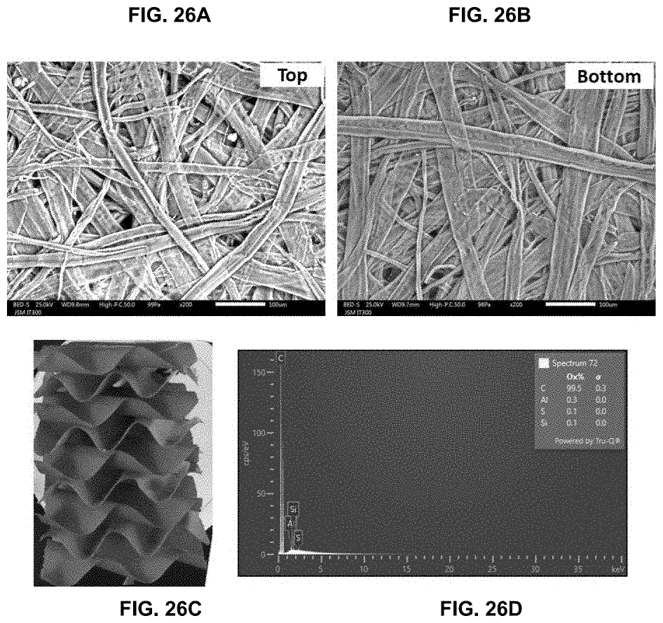

FIGS. 26A and 26B show top (FIG. 26A) and bottom (FIG. 26B) scanning electron micrographs of a cooling media sample of Munter's CELdek® treated with a non-oxidizing biocide according to an embodiment. FIG. 26C is a photograph of a portion of the media sample after an MOC test. FIG. 26D illustrates the result of an x-ray spectroscopy analysis on the media sample after the MOC test.

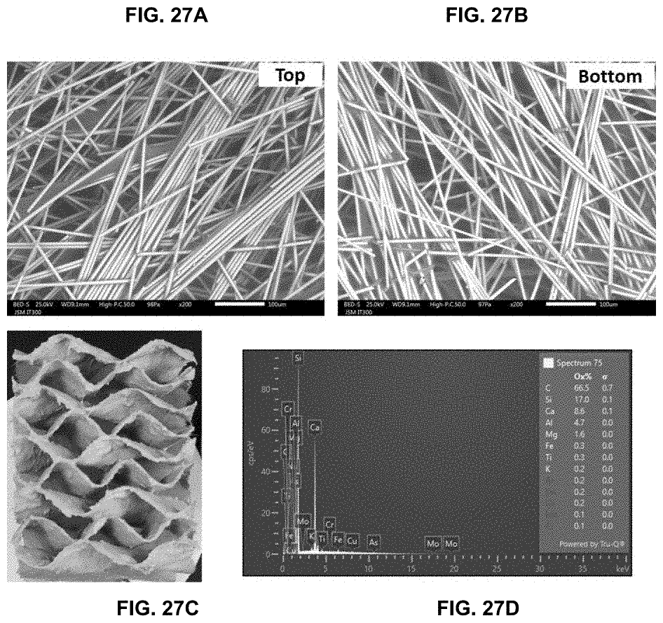

FIGS. 27A and 27B show top (FIG. 27A) and bottom (FIG. 27B) scanning electron micrographs of a cooling media sample of Munter's GLASdek® treated with a non-oxidizing biocide according to an embodiment. FIG. 27C is a photograph of a portion of the media sample after an MOC test. FIG. 27D illustrates the result of an x-ray spectroscopy analysis on the media sample after the MOC test.

### Example 11

Cooling media samples of Munter's CELdek® and Munter's GLASdek® were treated with a non-oxidizing biocide according to the biocide methodology in Table 1 above.

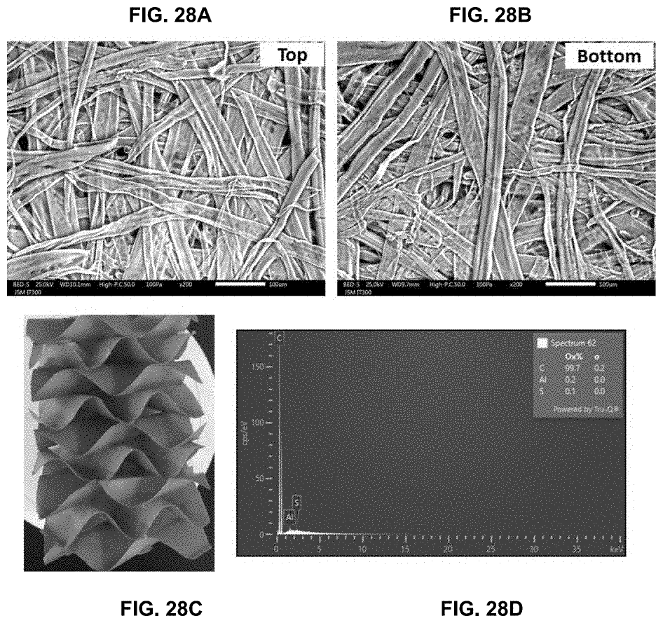

FIGS. 28A and 28B show top (FIG. 28A) and bottom (FIG. 28B) scanning electron micrographs of a cooling media sample of Munter's CELdek® treated with a non-oxidizing biocide according to an embodiment. FIG. 28C is a photograph of a portion of the media sample after an MOC test. FIG. 28D illustrates the result of an x-ray spectroscopy analysis on the media sample after the MOC test.

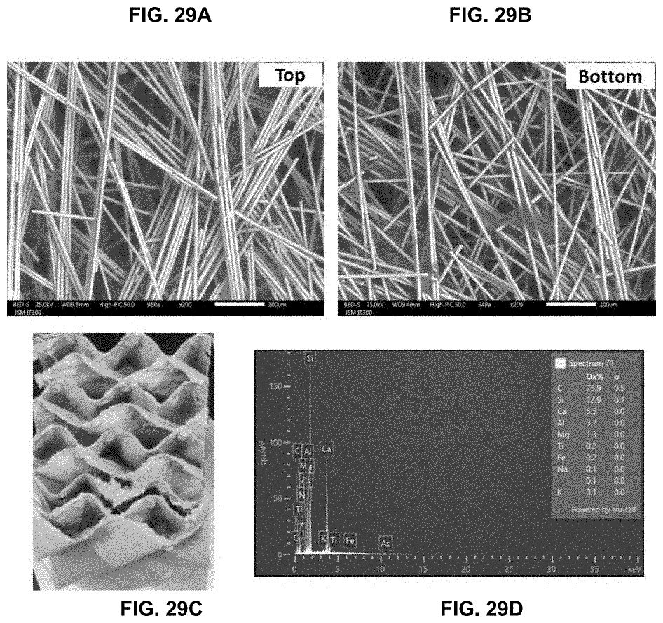

FIGS. 29A and 29B show top (FIG. 29A) and bottom (FIG. 29B) scanning electron micrographs of a cooling media sample of Munter's GLASdek® treated with a non-oxidizing biocide according to an embodiment. FIG. 29C is a photograph of a portion of the media sample after an MOC test. FIG. 29D illustrates the result of an x-ray spectroscopy analysis on the media sample after the MOC test.

### Example 12

Cooling media samples of Munter's CELdek® and Munter's GLASdek® were treated with a biodispersant according to the scale inhibitor methodology in Table 1 above.

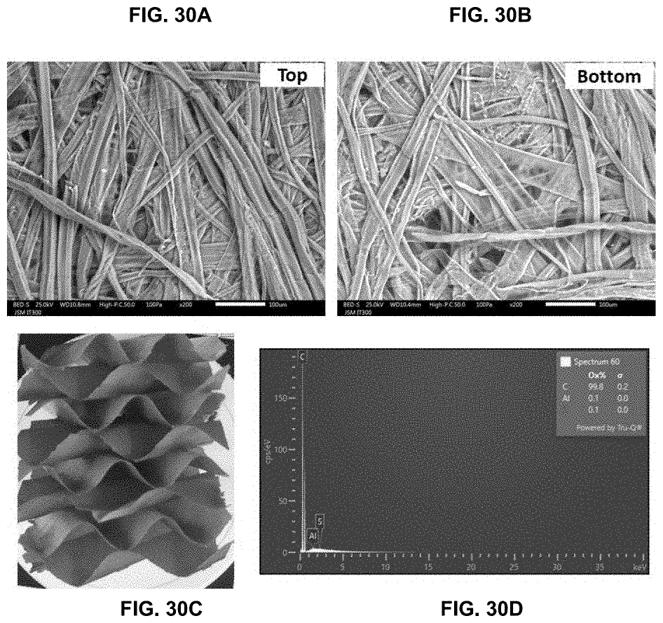

FIGS. 30A and 30B show top (FIG. 30A) and bottom (FIG. 30B) scanning electron micrographs of a cooling media sample of Munter's CELdek® treated with a biodispersant according to an embodiment. FIG. 30C is a photograph of a portion of the media sample after an MOC test. FIG. 30D illustrates the result of an x-ray spectroscopy analysis on the media sample after the MOC test.

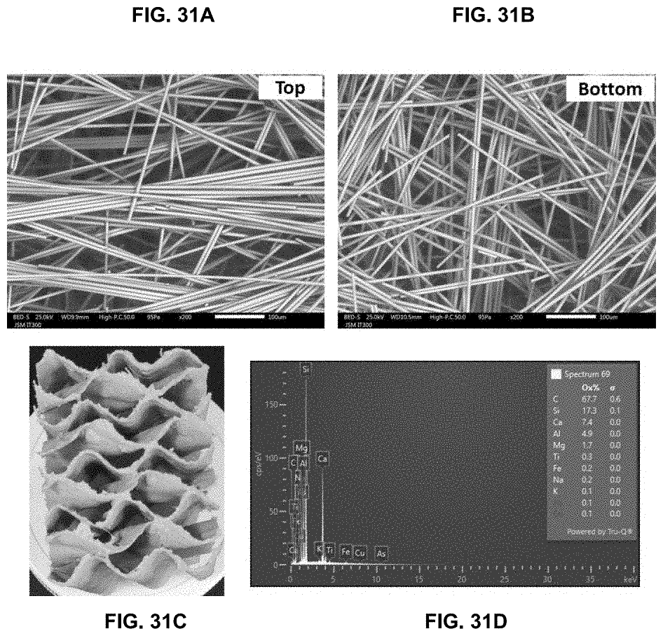

FIGS. 31A and 31B show top (FIG. 31A) and bottom (FIG. 31B) scanning electron micrographs of a cooling media sample of Munter's GLASdek® treated with a biodispersant according to an embodiment. FIG. 31C is a photograph of a portion of the media sample after an MOC test. FIG. 31D illustrates the result of an x-ray spectroscopy analysis on the media sample after the MOC test.

### Example 13

Cooling media samples of Munter's CELdek® and Munter's GLASdek® were treated with a phosphonate according to the scale inhibitor methodology in Table 1 above.

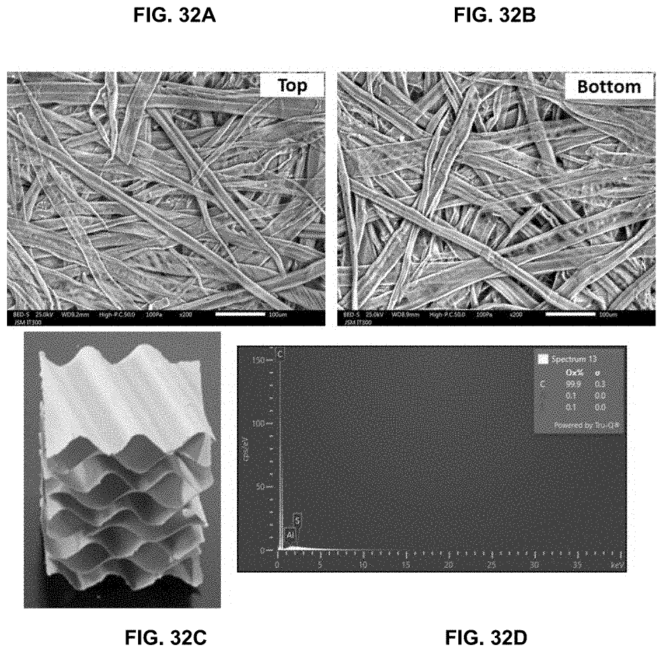

FIGS. 32A and 32B show top (FIG. 32A) and bottom (FIG. 32B) scanning electron micrographs of a cooling media sample of Munter's CELdek® treated with a phosphonate according to an embodiment. FIG. 32C is a photograph of a portion of the media sample after an MOC test. FIG. 32D illustrates the result of an x-ray spectroscopy analysis on the media sample after the MOC test.

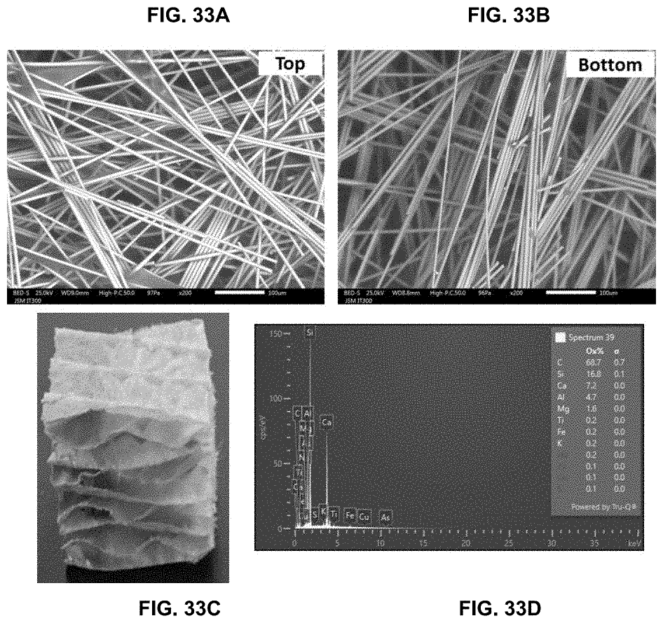

FIGS. 33A and 33B show top (FIG. 33A) and bottom (FIG. 33B) scanning electron micrographs of a cooling media sample of Munter's GLASdek® treated with a phosphonate according to an embodiment. FIG. 33C is a photograph of a portion of the media sample after an MOC test. FIG. 33D illustrates the result of an x-ray spectroscopy analysis on the media sample after the MOC test.

### Example 14

Cooling media samples of Munter's CELdek® and Munter's GLASdek® were treated with a phosphonate according to the scale inhibitor methodology in Table 1 above.

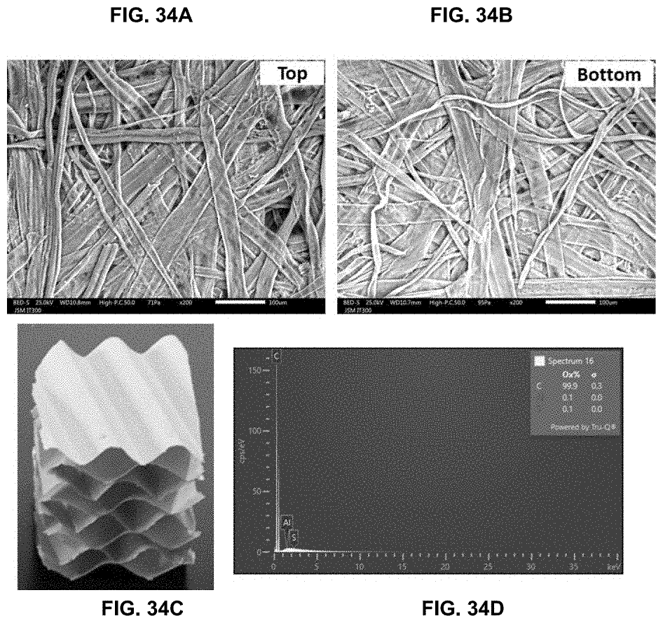

FIGS. 34A and 34B show top (FIG. 34A) and bottom (FIG. 34B) scanning electron micrographs of a cooling media sample of Munter's CELdek® treated with a phosphonate according to an embodiment. FIG. 34C is a photograph of a portion of the media sample after an MOC test. FIG. 34D illustrates the result of an x-ray spectroscopy analysis on the media sample after the MOC test.

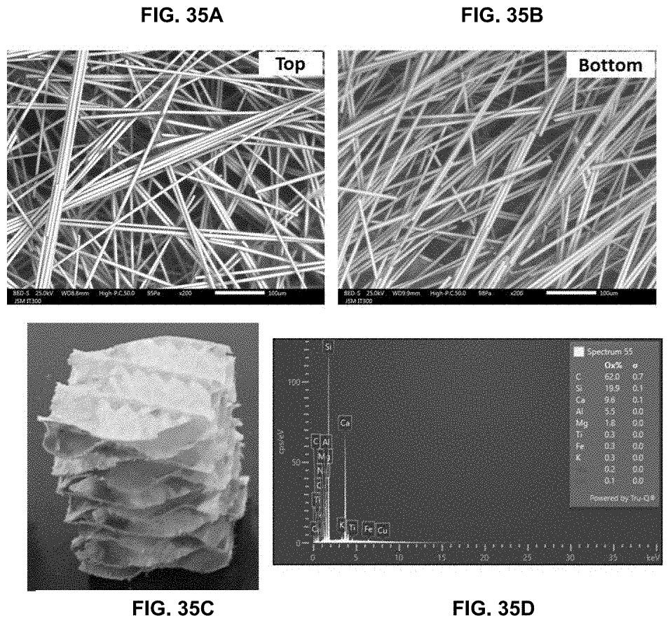

FIGS. 35A and 35B show top (FIG. 35A) and bottom (FIG. 35B) scanning electron micrographs of a cooling media sample of Munter's GLASdek® treated with a phosphonate according to an embodiment. FIG. 35C is a photograph of a portion of the media sample after an MOC test. FIG. 35D illustrates the result of an x-ray spectroscopy analysis on the media sample after the MOC test.

### Example 15

Cooling media samples of Munter's CELdek® and Munter's GLASdek® were treated with an azole according to the scale inhibitor methodology in Table 1 above.

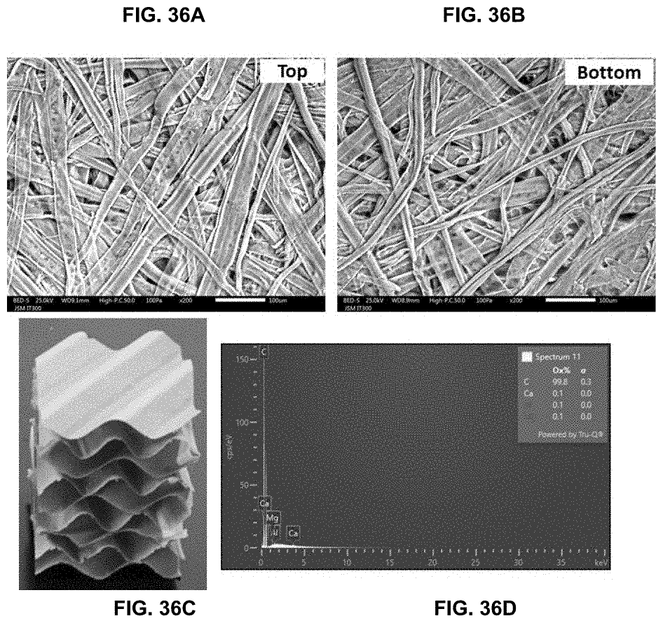

FIGS. 36A and 36B show top (FIG. 36A) and bottom (FIG. 36B) scanning electron micrographs of a cooling media sample of Munter's CELdek® treated with an azole according to an embodiment. FIG. 36C is a photograph of a portion of the media sample after an MOC test. FIG. 36D illustrates the result of an x-ray spectroscopy analysis on the media sample after the MOC test.

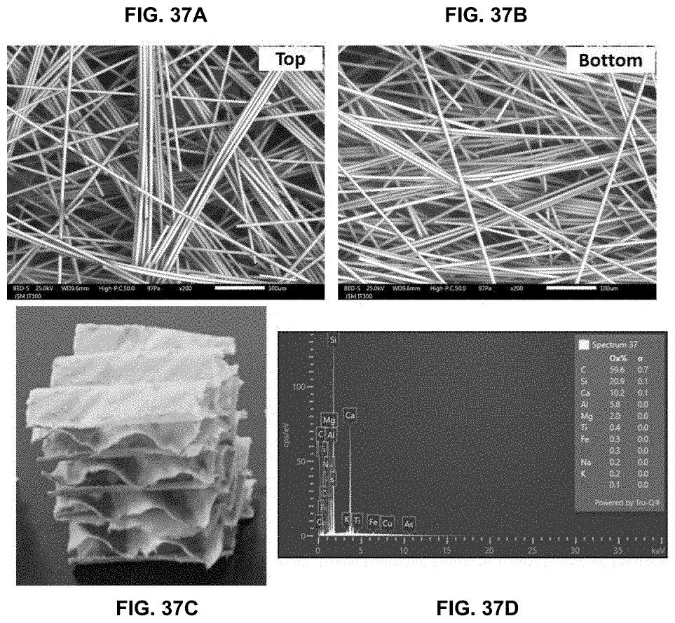

FIGS. 37A and 37B show top (FIG. 37A) and bottom (FIG. 37B) scanning electron micrographs of a cooling media sample of Munter's GLASdek® treated with an azole according to an embodiment. FIG. 37C is a photograph of a portion of the media sample after an MOC test. FIG. 37D illustrates the result of an x-ray spectroscopy analysis on the media sample after the MOC test.

### Example 16

Cooling media samples of Munter's CELdek® and Munter's GLASdek® were treated with a dispersant polymer according to the scale inhibitor methodology in Table 1 above.

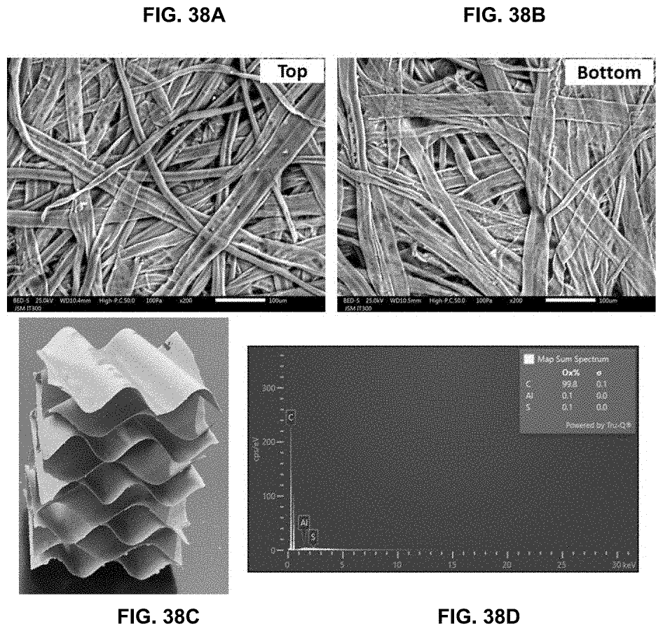

FIGS. 38A and 38B show top (FIG. 38A) and bottom (FIG. 38B) scanning electron micrographs of a cooling media sample of Munter's CELdek® treated with a dispersant polymer according to an embodiment. FIG. 38C is a photograph of a portion of the media sample after an MOC test. FIG. 38D illustrates the result of an x-ray spectroscopy analysis on the media sample after the MOC test.

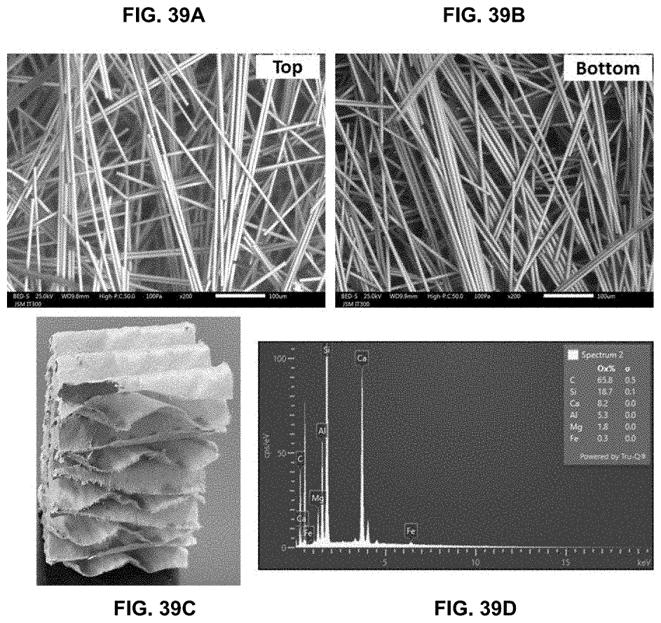

FIGS. 39A and 39B show top (FIG. 39A) and bottom (FIG. 39B) scanning electron micrographs of a cooling media sample of Munter's GLASdek® treated with a dispersant polymer according to an embodiment. FIG. 39C is a photograph of a portion of the media sample after an MOC test. FIG. 39D illustrates the result of an x-ray spectroscopy analysis on the media sample after the MOC test.

The results of the visual media analysis are summarized in Table 3 follows:

TABLE 3
Visual media analysis.

| Example | FIG. | Media | Observation |
|---|---|---|---|
| Baseline | FIG. 2C | CELdek ® | normal |
| Baseline | FIG. 3C | GLASdek ® | normal |
| Control | FIG. 4C | CELdek ® | normal |
| Control | FIG. 5C | GLASdek ® | normal |
| Comp. Example 1 | FIG. 6C | CELdek ® | collapse |
| Comp. Example 1 | FIG. 7C | GLASdek ® | collapse |
| Example 1 | FIG. 8C | CELdek ® | normal |
| Example 1 | FIG. 9C | GLASdek ® | normal |
| Example 2 | FIG. 10C | CELdek ® | normal |
| Example 2 | FIG. 11C | GLASdek ® | normal |
| Example 3 | FIG. 12C | CELdek ® | normal |
| Example 3 | FIG. 13C | GLASdek ® | normal |
| Example 4 | FIG. 14C | CELdek ® | normal |
| Example 4 | FIG. 15C | GLASdek ® | normal |
| Example 5 | FIG. 16C | CELdek ® | normal |
| Example 5 | FIG. 17C | GLASdek ® | normal |
| Example 6 | FIG. 18C | CELdek ® | normal |
| Example 6 | FIG. 19C | GLASdek ® | normal |
| Example 7 | FIG. 20C | CELdek ® | normal |
| Example 7 | FIG. 21C | GLASdek ® | normal |
| Example 8 | FIG. 22C | CELdek ® | normal |
| Example 8 | FIG. 23C | GLASdek ® | normal |
| Example 9 | FIG. 24C | CELdek ® | normal |
| Example 9 | FIG. 25C | GLASdek ® | normal |
| Example 10 | FIG. 26C | CELdek ® | normal |
| Example 10 | FIG. 27C | GLASdek ® | normal |
| Example 11 | FIG. 28C | CELdek ® | normal |
| Example 11 | FIG. 29C | GLASdek ® | normal |
| Example 12 | FIG. 30C | CELdek ® | normal |
| Example 12 | FIG. 31C | GLASdek ® | normal |
| Example 13 | FIG. 32C | CELdek ® | normal |
| Example 13 | FIG. 33C | GLASdek ® | normal |
| Example 14 | FIG. 34C | CELdek ® | normal |
| Example 14 | FIG. 35C | GLASdek ® | normal |
| Example 15 | FIG. 36C | CELdek ® | normal |
| Example 15 | FIG. 37C | GLASdek ® | normal |
| Example 16 | FIG. 38C | CELdek ® | normal |
| Example 16 | FIG. 39C | GLASdek ® | normal |

The results of the x-ray spectroscopy analysis are summarized in Table 4 follows:

TABLE 4
Sample x-ray spectroscopy analysis.

| Example | FIG. | Media | Observation |
|---|---|---|---|
| Baseline | FIG. 2D | CELdek ® | baseline |
| Baseline | FIG. 3D | GLASdek ® | baseline |
| Control | FIG. 4D | CELdek ® | no element contamination |
| Control | FIG. 5D | GLASdek ® | no element contamination |
| Comp. Exam- | FIG. 6D | CELdek ® | some element contamination |
| ple 1 | | | |
| Comp. Exam- | FIG. 7D | GLASdek ® | some element contamination |
| ple 1 | | | |
| Example 1 | FIG. 8D | CELdek ® | no element contamination |
| Example 1 | FIG. 9D | GLASdek ® | no element contamination |
| Example 2 | FIG. 10D | CELdek ® | no element contamination |
| Example 2 | FIG. 11D | GLASdek ® | no element contamination |
| Example 3 | FIG. 12D | CELdek ® | no element contamination |
| Example 3 | FIG. 13D | GLASdek ® | no element contamination |
| Example 4 | FIG. 14D | CELdek ® | no element contamination |
| Example 4 | FIG. 15D | GLASdek ® | no element contamination |
| Example 5 | FIG. 16D | CELdek ® | no element contamination |
| Example 5 | FIG. 17D | GLASdek ® | no element contamination |
| Example 6 | FIG. 18D | CELdek ® | no element contamination |
| Example 6 | FIG. 19D | GLASdek ® | no element contamination |
| Example 7 | FIG. 20D | CELdek ® | no element contamination |
| Example 7 | FIG. 21D | GLASdek ® | no element contamination |
| Example 8 | FIG. 22D | CELdek ® | no element contamination |
| Example 8 | FIG. 23D | GLASdek ® | no element contamination |
| Example 9 | FIG. 24D | CELdek ® | no element contamination |
| Example 9 | FIG. 25D | GLASdek ® | no element contamination |
| Example 10 | FIG. 26D | CELdek ® | no element contamination |
| Example 10 | FIG. 27D | GLASdek ® | no element contamination |
| Example 11 | FIG. 28D | CELdek ® | no element contamination |
| Example 11 | FIG. 29D | GLASdek ® | no element contamination |
| Example 12 | FIG. 30D | CELdek ® | no element contamination |
| Example 12 | FIG. 31D | GLASdek ® | no element contamination |
| Example 13 | FIG. 32D | CELdek ® | no element contamination |
| Example 13 | FIG. 33D | GLASdek ® | no element contamination |
| Example 14 | FIG. 34D | CELdek ® | no element contamination |
| Example 14 | FIG. 35D | GLASdek ® | no element contamination |
| Example 15 | FIG. 36D | CELdek ® | no element contamination |
| Example 15 | FIG. 37D | GLASdek ® | no element contamination |
| Example 16 | FIG. 38D | CELdek ® | no element contamination |
| Example 16 | FIG. 39D | GLASdek ® | no element contamination |

As seen in Tables 3 and 4 above, treatment of cooling media with chemical treatment according to embodiments resulted in no compatibility problems, i.e., no collapse, biofouling, or elemental contamination. In contrast, treatment with sulfuric acid (Comparative Example 1) resulted in collapse of the media walls and some elemental contamination. These results clearly suggest the surprising compatibility of chemical treatments according to the disclosed embodiments on cooling media.

### Experiment 2

CaCO₃ scale inhibition was measured across four plants having water chemistries illustrated in Table 5 below.

TABLE 5
Water chemistry.

| | Plant #1 | Plant #2 | Plant #3 | Plant #4 | AVG | 5× | 10× |
|---|---|---|---|---|---|---|---|
| pH | 7.48 | 7.6 | 7.37 | 7.51 | 7.49 | 8.63 | 8.63 |
| Calcium as CaCO₃ (ppm) | 90 | 76 | 84 | 86 | 84 | 420 | 840 |
| Magnesium as CaCO₃ (ppm) | 33 | 28 | 30 | 30 | 30 | 150 | 300 |
| M Alkalinity as CaCO₃ (ppm) | 79 | 65 | 71 | 71 | 71.5 | 357.5 | 715 |
| Chloride at Cl (ppm) | 16 | 17 | 16 | 16 | 16.3 | 81.5 | 163 |
| Sulfate as SO₄ (ppm) | 30 | 27 | 30 | 31 | 29.5 | 147.5 | 295 |
| Phosphate as PO₄ (ppm) | 1.2 | 1.7 | 1.4 | 1.4 | 1.43 | 7.15 | 14.3 |
| Silica as SiO₂ (ppm) | 4 | 6.1 | 5.2 | 5 | 5 | 25 | 50 |
| Temperature (F.) | | | | | 78.8 | | |

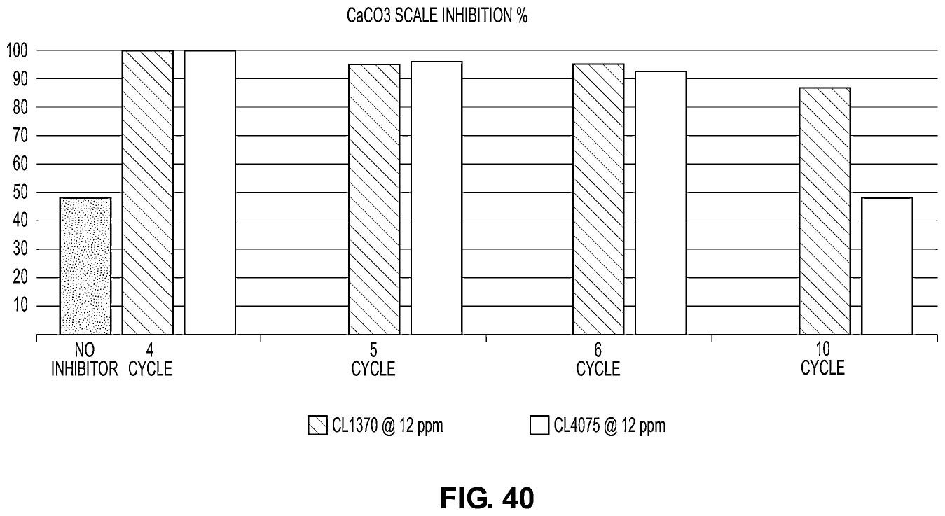

Each of the plants had cooling media treated with CL 1370/4075 according to embodiments. The results are illustrated in FIG. 40. As seen in FIG. 40, significant CaCO₃ scale inhibition was observed for up to 10 cycles.

### Experiment 3

Ca₃(PO₄)₂ scale inhibition was measured across the same four plants as in Experiment 3 having the water chemistries illustrated in Table 5 above.

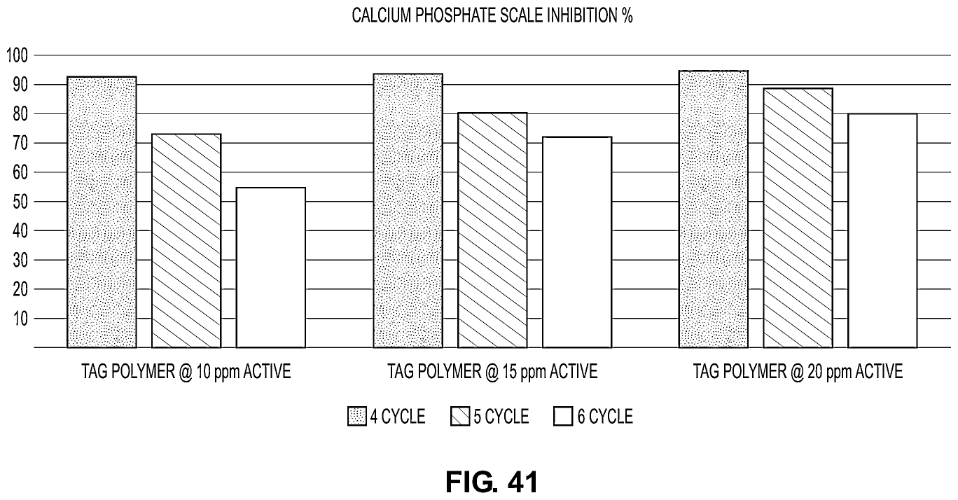

Each of the plants had cooling media treated with a dispersant polymer according to embodiments. The results are illustrated in FIG. 41. As seen in FIG. 41, significant Ca₃(PO₄)₂ scale inhibition was observed for 10 to 20 ppm of the chemical treatment for up to 6 cycles.

It will be appreciated that the above-disclosed features and functions, or alternatives thereof, may be desirably combined into different methods and systems. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method for applying a chemical treatment to a cooling medium in an evaporative cooling system, the method comprising:
applying the chemical treatment to the cooling medium,
wherein the chemical treatment comprises at least one of a phosphonate and a dispersant polymer.

2. The method for applying a chemical treatment according to claim 1, wherein the chemical treatment includes the phosphonate and the dispersant polymer.

3. The method for applying a chemical treatment according to claim 1, wherein the chemical treatment further comprises at least one selected from the group consisting of a scale inhibitor, a chelating agent, and a biocide.

4. The method for applying a chemical treatment according to claim 1, wherein the chemical treatment further comprises a fluorescent tracer.

5. The method for applying a chemical treatment according to claim 1, wherein the cooling medium comprises cellulose or silicon dioxide.

6. The method for applying a chemical treatment according to claim 5, wherein the cooling medium further comprises at least one selected from the group consisting of epoxy resin, silicone, cyanoacrylate, polyvinylacetate, polyester, vinyl ester, halogenated organophosphorus compound, acrylic polymer, vinyl-acrylic copolymer, styrene-butadiene copolymer, styrene-acrylonitrile-butadiene copolymer, and vinyl ester-ethylene or latex.

7. The method for applying a chemical treatment according to claim 1, wherein the applying step includes coating a surface of the cooling medium with a chemical treatment.

8. The method for applying a chemical treatment according to claim 1, further comprising adding the chemical treatment to a process stream in the evaporative cooling system before the applying step,
wherein the applying step includes contacting the cooling medium with the process stream.

9. The method for applying a chemical treatment according to claim 1, wherein the chemical treatment is applied continuously or intermittently, with treatment occurring more than 50% of the time.

10. The method for applying a chemical treatment according to claim 1, wherein the chemical treatment is applied intermittently in a range of 5 to 40 cycles.

11. The method for applying a chemical treatment according to claim 1, wherein a conductivity of the process stream is more than 5000 μS/cm.

12. The method for applying a chemical treatment according to claim 1, wherein total dissolved solids in the process stream is more than 2500 ppm.

13. The method for applying a chemical treatment according to claim 1, wherein the chemical treatment is in solid form.

14. The method for applying a chemical treatment according to claim 1, wherein the chemical treatment is in liquid form.

15. The method for applying a chemical treatment according to claim 1, wherein during the application step a concentration of the chemical treatment eluting through a membrane of a cooling medium in the evaporative cooling system is in a range of 1 and 50 ppm.

16. The method for applying a chemical treatment according to claim 1, wherein the chemical treatment includes the phosphonate, and the phosphonate is at least one organic phosphonate selected from the group consisting of 2-phosphonobutane-1,2,4-tricarboxylic acid (PBTC), 1-hydroxy ethylidene-1,1-diphosphonic acid (HEDP), amino tris methylene phosphonic acid (ATMP), 2-hydroxyphosphonocarboxylic acid (HPA), diethylenetriamine penta(methylene phosphonic acid) (DETPMP), and phosphinosuccinic oligomer (PSO).

17. The method for applying a chemical treatment according to claim 1, wherein the phosphonate is included in the chemical treatment in a range of 10% to 95 wt % of the chemical treatment.

18. The method for applying a chemical treatment according to claim 1, wherein the chemical treatment includes the dispersant polymer, and the dispersant polymer is at least one carboxylic acid polymer selected from the group consisting of polyacrylic acid, homo or co-polymaleic acid, acrylate, 2-acrylamido-2-methylpropane sulfonic acid (AMPS) copolymers, acrylate or acrylamide copolymers, acrylate homopolymers, terpolymers of carboxylate, sulfonate, or maleate, terpolymers of acrylic acid or AMPS.

19. The method for applying a chemical treatment according to claim 1, wherein the dispersant polymer is included in the chemical treatment in a range of 10% to 95 wt % of the chemical treatment.

20. The method for applying a chemical treatment according to claim 1, wherein the chemical treatment is added to the cooling medium in an amount sufficient to sustain a microstructure of the cooling medium under an exposure duration of 30 days or more.
